(19) United States
(12) Patent Application Publication
(10) Pub. No.: US 2024/0224376 A1
(43) Pub. Date: Jul. 4, 2024

(54) SIMULTANEOUS DRX CONFIGURATIONS AND HARQ TIMER ENHANCEMENTS FOR XR TRAFFIC

(71) Applicant: Apple Inc., Cupertino, CA (US)

(72) Inventors: Weidong Yang, San Diego, CA (US); Arjun Bharadwaj, Sunnyvale, CA (US); Dawei Zhang, Saratoga, CA (US); Fangli Xu, Beijing (CN); Haijing Hu, Los Gatos, CA (US); Hong He, San Jose, CA (US); Huaning Niu, San Jose, CA (US); Lakshmi Iyer, Cupertino, CA (US); Murali Narasimha, San Ramon, CA (US); Ralf Rossbach, Munich (DE); Sarma V. Vangala, Campbell, CA (US); Sigen Ye, Whitehouse Station, NJ (US); Wei Zeng, Saratoga, CA (US); Oghenekome Oteri, San Diego, CA (US); Haitong Sun, Cupertino, CA (US); Chunxuan Ye, San Diego, CA (US); Chunhai Yao, Beijing (CN); Yushu Zhang, Beijing (CN)

(73) Assignee: Apple Inc., Cupertino, CA (US)

(21) Appl. No.: 17/910,341

(22) PCT Filed: Sep. 24, 2021
(86) PCT No.: PCT/CN2021/120443

§ 371 Date: Mar. 30, 2023

(51) Int. Cl. H04W 76/28; H04L 1/1829; H04L 5/00; H04W 72/231

(52) U.S. Cl. CPC H04W 76/28; H04L 1/1854; H04L 5/0055; H04W 72/231

(57) ABSTRACT

Provided is a method for a user equipment (UE). The UE obtains a first control information from a network device. The first control information indicates at least one physical downlink control channel (PDCCH) monitoring period for the UE. The UE further monitors PDCCH based on the at least one PDCCH monitoring period.

### CROSS REFERENCE TO RELATED APPLICATION

This application is a 371 U.S. National Phase of PCT International Patent Application No. PCT/CN2021/120443, filed Sep. 24, 2021, which is herein incorporated by reference in its entirety for all purposes.

### TECHNICAL FIELD

This application relates generally to wireless communication systems, and more specifically to simultaneous Discontinuous Reception (DRX) configurations and Hybrid Automatic Repeat Request (HARQ) timer enhancements for Extended Reality (XR) traffic.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node, such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node, or g Node B (gNB), which communicate with a wireless communication device, also known as user equipment (UE).

### SUMMARY

According to an aspect of the present disclosure, a method for a user equipment (UE) is provided that includes: obtaining first control information from a base station (BS), where the first control information indicates at least one physical downlink control channel (PDCCH) monitoring period for the UE; and monitoring PDCCH based on the at least one PDCCH monitoring period.

According to an aspect of the present disclosure, a method for a network device is provided that includes: determining a traffic behavior for a UE, where the traffic behavior includes a plurality of traffic compositions and a traffic pattern for each of the plurality of traffic composition; and generating a first control information for transmission to the UE based on the traffic behavior, where the first control information indicates at least one physical downlink control channel (PDCCH) monitoring period for the UE.

According to an aspect of the present disclosure, an apparatus for a user equipment (UE) is provided that includes one or more processors configured to perform steps of the method according to the present disclosure.

According to an aspect of the present disclosure, an apparatus of a network device is provided that includes one or more processors configured to perform steps of the method according to the present disclosure.

According to an aspect of the present disclosure, a computer-readable medium is provided that has computer programs stored thereon, which when executed by one or more processors, cause an apparatus to perform steps of the method according to perform steps of the method according to the present disclosure.

According to an aspect of the present disclosure, an apparatus for a communication device is provided that includes means for performing steps of the method according to perform steps of the method according to the present disclosure.

According to an aspect of the present disclosure, a computer program product is provided that includes computer programs which, when executed by one or more processors, cause an apparatus to perform steps of the method according to the present disclosure.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a user equipment in accordance with some embodiments.

FIG. 3 illustrates an example ASN.1. for MAC-CellGroupConfig and DRX-Config.

FIG. 4A-4B illustrates an example ASN.1. for DRX-Config.

FIG. 5 illustrates an example of taking effect time corresponding to a MAC CE.

FIG. 6 illustrates an example of WUS behavior with respect to a DRX On period.

FIG. 7 illustrates an example timeline for drx-HARQ-RTT-TimerDL and drx-RetransmissionTimerDL.

FIG. 8 illustrates an example timeline for drx-HARQ-RTT-TimerUL and drx-RetransmissionTimerUL.

FIG. 9 illustrates an example ASN.1. for HARQ related timers associated with each of Cap #1 and Cap #2 respectively.

FIG. 10 illustrates examples of a PDCCH monitoring period due to non-common parameters overlaps with a DRX On period.

FIG. 11 illustrates a flowchart for an exemplary method for a network device in accordance with some embodiments.

FIG. 12 illustrates an exemplary block diagram of an apparatus for a UE in accordance with some embodiments.

FIG. 13 illustrates an exemplary block diagram of an apparatus for a network device in accordance with some embodiments.

FIG. 14 illustrates example components of a device in accordance with some embodiments.

FIG. 15 illustrates example interfaces of baseband circuitry in accordance with some embodiments.

FIG. 16 illustrates components in accordance with some embodiments.

FIG. 17 illustrates an architecture of a wireless network in accordance with some embodiments.

### DETAILED DESCRIPTION

In the present disclosure, a “base station” can include a RAN Node, such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB; such devices may be replaced with any type of base station.

In wireless communication, a Medium Access Control (MAC) entity may be configured by RRC with a DRX functionality that controls the UE's PDCCH monitoring activity for the MAC entity's C-RNTI, CS-RNTI, INT-RNTI, SFI-RNTI, SP-CSI-RNTI, TPC-PUCCH-RNTI, TPC-PUSCH-RNTI, and TPC-SRS-RNTI. When using DRX operation, the MAC entity shall also monitor PDCCH according to requirements found in other subclauses of this specification. When in RRC_CONNECTED, if DRX is configured, for all the activated Serving Cells, the MAC entity may monitor the PDCCH discontinuously using the DRX operation specified in this subclause; otherwise, the MAC entity shall monitor the PDCCH as specified in TS 38.213.

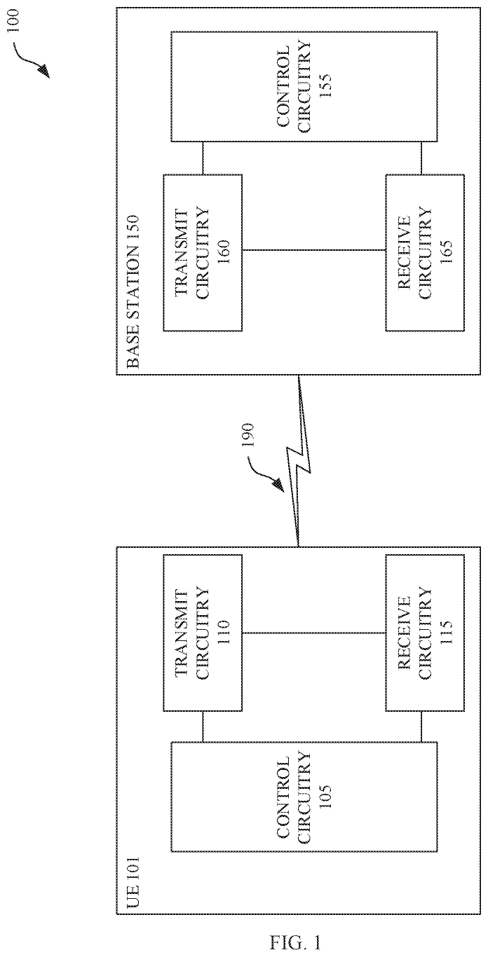

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices, such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120 degree area with an array of antennas directed to each sector to provide 360 degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations, such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHZ. In other embodiments, other bandwidths may be used. The control circuitry 155 may perform various operations, such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The UE and the network device described in the following embodiments may be implemented by the UE 101 and the base station 150 described in FIG. 1.

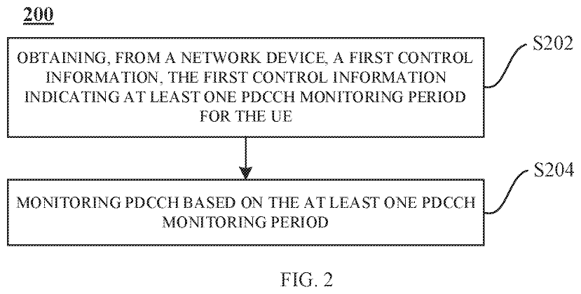

FIG. 2 illustrates a flowchart for an exemplary method for a user equipment in accordance with some embodiments. The method 200 illustrated in FIG. 2 may be implemented by the UE 101 described in FIG. 1.

In some embodiments, the method 200 for UE may include the following steps: S202, obtaining, from a network device, a first control information, the first control information indicating at least one physical downlink control channel (PDCCH) monitoring period for the UE; and S204, monitoring PDCCH based on the at least one PDCCH monitoring period.

According to the embodiments of the present application, UE monitor PDCCH based on the determined at least one PDCCH monitoring period to facilitate UE power saving.

Simultaneous DRX configurations with enhanced HARQ timer for addressing multiple data flows for XR are provided in the present disclosure. Specifically, multiple solutions to configure multiple DRX configurations for multiple data flows of XR traffic and multiple solutions to maintain a “configured set” and an “active set” of DRX configurations are provided, and new behavior for wake-up signal (WUS) with respect to multiple DRX configurations are also provided. Additionally or alternatively, specific treatments for HARQ retransmission timers are provided.

Extended Reality (XR) traffic can have multiple data flows, namely traffic compositions, and a traffic pattern for each traffic composition. In an exemplary Augmented Reality (AR) uplink (UL) traffic model, there can be a video stream (60 Hz), an audio/data stream (100 Hz), and a pose/control stream (250 Hz). In an exemplary AR downlink (DL) traffic model, there can be a video stream (60 Hz), and an audio/data stream (100 Hz).

According to some embodiments, the method may further include: determining a traffic behavior of the UE for transmission to the network device. The network device may generate the first control information based on UE's traffic behavior so that multiple DRX configuration configured by the network device is tailored for the XR traffic.

According to some embodiments, a plurality of DRX configurations transmitted to the UE over the first control information can be configured simultaneously to handle multiple data flows, and each of the plurality of DRX configurations may indicate at least one DRX On period based on the corresponding DRX-Config parameters. For each DRX-Config, the following can be configured separately:
drx-onDurationTimer
drx-InactivityTimer
drx-HARQ-RTT-TimerDL
drx-HARQ-RTT-TimerUL
drx-RetransmissionTimerDL
drx-RetransmissionTimerUL
drx-LongCycleStartOffset

According to some embodiments, all the parameters under DRX-Config can be individually configured, and a list of DRX-Config is maintained under a MAC cell group.

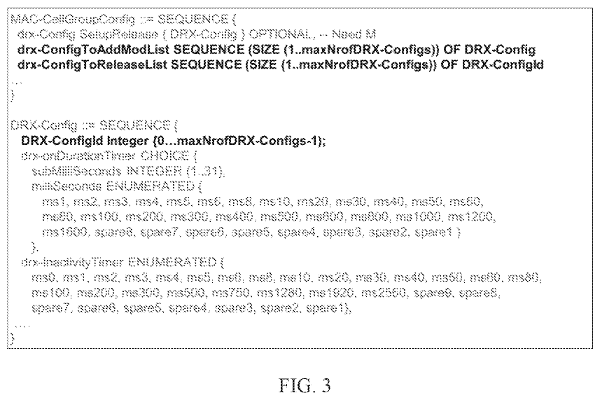

As can be seen, an exemplary cell group configuration is described with reference to FIG. 3. FIG. 3 illustrates an example Abstract Syntax Notation One (ASN.1.) for MAC-CellGroupConfig and DRX-Config. Each of DRX configurations is associated with a DRX-ConfigId in DRX-Config to facilitate RRC configuration, RRC reconfiguration or MAC CE selection. The list of DRX-Config is maintained by drx-ConfigToAddModList and the list of DRX-ConfigId is maintained by drx-ConfigToReleaseList.

According to some embodiments, at S204, monitor the PDCCH based on the respective at least one DRX On period indicated by each of the plurality of DRX configurations. In an exemplary embodiment, the union of the respective DRX On period indicated by each DRX configuration may define occasions for the UE to monitor PDCCH. By monitoring the PDCCH based on the respective DRX On period indicated by each DRX configuration, the UE is able to save power by not monitoring PDCCH when none of data streams is present in a DRX Off period without missing PDCCH for any data stream.

However, allowing full flexibility may create problem in UE implementation. Assume some parameters are configured differently in DRX-Configs say for config-1 or config-2, there may be an issue for UE to determine it is “On” due to config-1 or config-2, hence different parameters, such as drx-InactivityTimer, would apply for respective cases. To avoid such complications, the following design can be used, so the parameters for all DRX On period are guaranteed to be the same.

According to some embodiments, the first control information may include a modified DRX configuration. The modified DRX configuration may indicate a plurality of DRX On period sets by a plurality of configurable parameter sets, respectively, and each of the plurality of parameter sets may include at least one of a periodicity and an offset. In this way, a single modified DRX configuration is able to handle multiple data streams with different periodicities and/or different offsets.

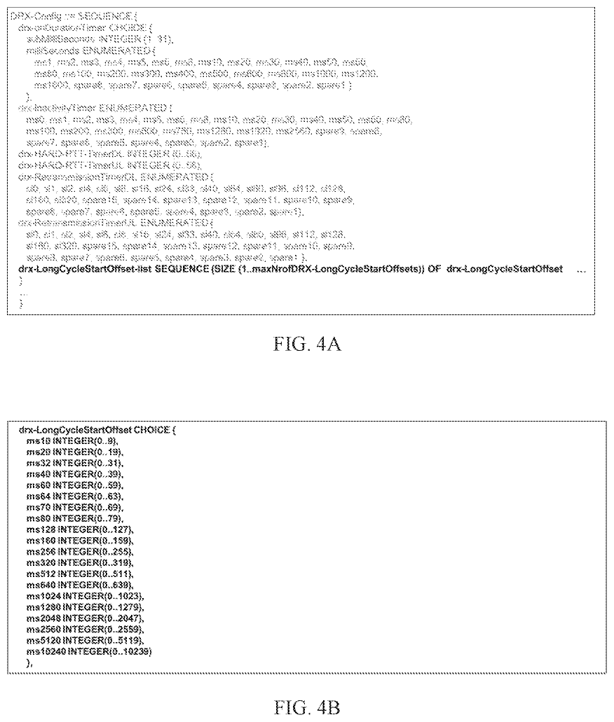

According to some embodiments, an exemplary modified DRX configuration is described with reference to FIG. 4A-4B. FIG. 4A-4B illustrates an example ASN.1. for DRX-Config. The DRX-Config maintains a list of drx-LongCycleStarOffset-list, and each element (drx-LongCycleStarOffset) in the list, as a configurable parameter set, includes two parameters of a periodicity and an offset. Other DRX parameters, such as drx-onDurationTimer, are not separately configurable for each data stream. drx-LongCycleStarOffset-list may include the support of non-integer periodicity, such as 60 Hz, 90 Hz, etc., to avoid mismatch with some data streams periodicity in XR, such as the video stream's periodicity.

According to some embodiments, at S204, monitor PDCCH based on the plurality of DRX On period sets. In an exemplary embodiment, each configurable parameter set may define DRX On periods along with other parameters, and the union of the respective DRX On periods indicated by each of the plurality of configurable parameter sets may define occasions for the UE to monitor PDCCH.

It is understandable that the above solution should work well if the traffic pattern or traffic composition does not change. To support traffic pattern and/or traffic composition adaption, the following solution can be considered.

According to some embodiments, a main DRX-Config and one or more aux DRX-Configs are defined, where all parameters for the aux DRX-Configs should follow the configuration of DRX-Config but a small set of configurable parameters, e.g., periodicity and/or offset. Some or all of these DRX-Configs may be transmitted to the UE over the first control information, but are not configured for the UE at once. A “configured set” and an “active set” may be maintained by the UE, specifying DRX-Configs stored in the UE and DRX-Configs configured to be active for the UE, respectively.

According to some embodiments, the method may further include: obtaining a third control information from the network device. The third control information causes the UE to perform at least one operation selected from a group consisting of: modification of at least one DRX configuration of the plurality of DRX configurations; addition of at least one DRX configuration to the plurality of DRX configurations; and removal of at least one DRX configuration from the plurality of DRX configurations. In this way, the network device is able to modify the “configured set”.

According to some embodiments, the third control information is transmitted via an RRC signaling message, thus the “configured set” is configured by a RRC configuration.

According to some embodiments, the method may further include: obtaining a second control information from the network device. The second control information causes the UE to perform at least one operation selected from a group consisting of: activation of at least one DRX configuration of the plurality of DRX configurations; and deactivation of at least one DRX configuration of activated DRX configurations. In this way, the network device is able to modify the “active” set.

According to some embodiments, the third control information is transmitted via an RRC signaling message, thus the “active set” is also configured by a RRC configuration. It is understandable that any operation to the “active set” should be constrained with the “configured set”.

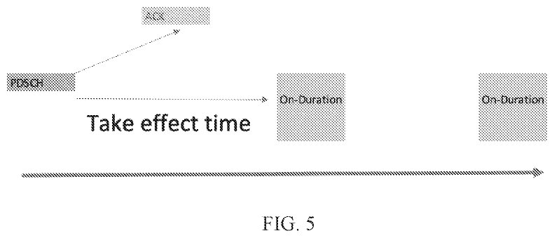

However, RRC configurations may raise an issue of causing an ambiguity period between the UE and the network device. According to some embodiments, the third control information is transmitted via a MAC CE, thus the “active set” is configured by the MAC CE. Further, a corresponding taking effect time is set to overcome this ambiguity issue. As can be seen, FIG. 5 shows an example taking effect time corresponding to a MAC CE.

According to some embodiments, the taking effect time of the activation/deactivation of the corresponding DRX configurations is selected from a group consisting of:
after a first nominal DRX On period after a Hybrid Automatic Repeat Request (HARQ) acknowledgement (HARQ-ACK) for the Physical Downlink Shared Channel (PDSCH) containing the MAC CE;
a first predetermined time after the HARQ-ACK for the PDSCH containing the MAC CE, e.g., 3 ms;
at a boundary of a time unit selected from a group consisting of a slot, half-radio frame, and a radio frame;
a second predetermined time after a transmission of an uplink MAC CE by the UE upon a reception of the MAC CE associated with the second control information.

It is understandable that those skilled in the art can set the value for these predetermined times according to their requirements, and is not limited in here.

Following are two exemplary embodiments for configuring a “configured set” and an “active set”. In an exemplary embodiment, a video data flow can be at 30 Hz, 60 Hz, or 120 Hz depending on link quality, and an audio/data flow can be at 100 Hz. Media encoder of the UE picks 60 fps (60 Hz) initially, with the traffic information provided by the UE with UE assistance information. The network device configures DRX configurations at 30 Hz, 60 Hz, 120 Hz (video), and 100 Hz (audio/data) as a “configured set”, with an initial “active set” at 60 Hz (video) and 100 Hz (audio). After a while, the link quality deteriorates, and the media encoder changes the frame rate to 30 Hz. The UE informs the network device that, and the network device sends an MAC CE to activate 30 Hz DRX configuration (video), and deactivate the 60 Hz DRX configuration (video), After that, the “active set” consists of 30 Hz (video) and 100 Hz (audio/data).

In another exemplary embodiment, the network device initially configures only 60 Hz (video) for a single DRX configuration, as the “configured set”. With UE assistance information, the network device uses RRC signaling to configure 30 Hz, 120 Hz (video), and 100 Hz (audio/data) DRX configurations (add to the “configure set”), hence no interruption to the ongoing traffic, no ambiguity between network device and the UE. After the RRC ambiguity time, the network device uses MAC CE to add 100 Hz (audio/data) DRX configuration to the “active set”.

According to some embodiments, the DRX adaption can be achieved by dynamical signaling. The first control information includes a plurality of DRX configuration sets. Each of the plurality of DRX configuration sets includes at least one DRX configuration, and each of the at least one DRX configuration indicates at least one DRX On period. The method may further include: obtaining a fourth control information from the network device. The fourth control information indicates a target DRX configuration set from the plurality of DRX configuration sets. In this way, the UE may store multiple DRX configuration sets transmitted over the first control information, and each set includes one or more preset DRX configurations that are bound to be activated or deactivated simultaneously.

According to some embodiments, at S204, monitor PDCCH based on the respective at least one DRX On period indicated by each of at least one DRX configuration included in the target DRX configuration. By selecting one DRX configuration set, all DRX configurations in this set are activated, and the union of corresponding DRX On periods defines occasions for the UE to monitor PDCCH, while all DRX configurations in other sets are deactivated or remains deactivated, thus a convenient solution for configuring multiple DRX configurations is introduced.

According to some embodiments, the fourth control information is transmitted via dynamic signaling of a Downlink Control Information (DCI), and a plurality of code states of the DCI corresponds to the plurality of DRX configuration sets, respectively.

In an exemplary embodiment, the following code state in a DCI is associated with one or more DRX configurations:
Code State 1: {30 Hz with offset 1}
Code State 2: {30 Hz with offset 2}
Code State 3: {30 Hz with offset *}, “*” is determined through another means
Code State 4: {30 Hz with offset 1, 100 Hz with offset 4}
Code State 5: {60 Hz with offset 1, 100 Hz with offset 4}

In this way, the DRX adaption is indicated by a DCI (the code state of a DCI to be precise) from a network device, and a more convenient solution for configuring multiple DRX configurations are introduced.

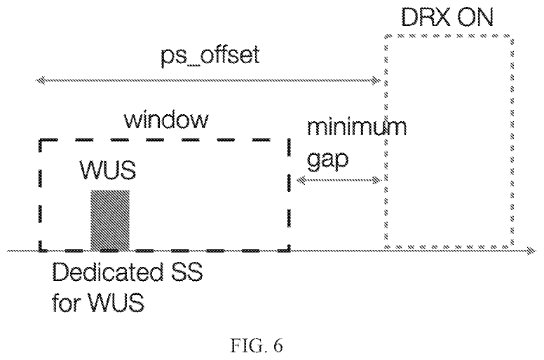

According to some embodiments, the current wake-up signal (WUS) behavior is regulated by ps-Offset and minimum time gap value with respect to the start time of drx-onDurationTimer. FIG. 6 shows an example WUS behavior with respect to a DRX On period. With simultaneous DRX configurations, the same rule can be used, only adaptation is the drx-onDurationTimer can be any one of multiple DRX configurations.

According to some embodiments, a single WUS configuration can be configured for all DRX configurations. The method may further include obtaining a fifth control information from the network device. The fifth control information includes a WUS configuration indicating at least one wake-up period associated with the respective at least one DRX On period indicated by each of the plurality of DRX configurations. If a portion of window defined by ps-Offset and minimum time gap value relative to the start time of drx-onDurationTimer of one DRX configuration overlaps with the DRX On time of another DRX configuration, then the UE does not monitor the WUS during the portion of the window. The portion of the window can the whole of the window.

According to some embodiments, at S204, monitoring PDCCH based on the respective at least one DRX On period indicated by each of the plurality of DRX configurations and the at least one wake-up period indicated by the WUS configuration. In this way, each DRX On period can be associated with a WUS indicating whether the UE is not required to monitor the corresponding DRX On period, and thus UE power saving is achieved.

Since different data flows can have different jitters, to use different WUSs for different data flows can be also motivated. With that, there can be multiple WUS configurations, e.g., with ps-offset 1, ps-offset 2, etc., with respect to different data flows. According to some embodiments, the method may further include obtaining a sixth control information from the network device. The sixth control information includes a plurality of WUS configurations corresponding to the plurality of traffic compositions, respectively. The plurality of WUS configuration indicates at least one wake-up period associated with the at least one PDCCH monitoring period.

According to some embodiments, at S204, monitor PDCCH based on the at least one PDCCH monitoring period and the at least one wake-up period.

A linkage can be created between a DRX configuration and a corresponding WUS configuration. If 1-1 mapping is established, then the maintenance of the “active set” of DRX configurations can be naturally used for WUS configurations maintenance. According to some embodiments, the method may further include obtaining a seventh control information from the network device. The seventh control information includes a plurality of WUS configurations corresponding to the plurality of DRX configurations, respectively, and each of the plurality of WUS configuration indicates at least one wake-up period associated with at least one DRX On period indicated by a corresponding DRX configurations.

According to some embodiments, at S204, monitor PDCCH based on the respective at least one DRX On period indicated by each of the plurality of DRX configurations and the respective at least one wake-up period indicated by each of the plurality of WUS configurations.

Following is an exemplary embodiment for simultaneous DRX configurations. In an exemplary embodiment, in the AR UL traffic model, there can be a video stream (60 Hz), audio/data stream (100 Hz), and pose/control stream (250 Hz). In the AR DL traffic model, there can be a video stream (60 Hz), audio/data stream (100 Hz). Two simultaneous DRX configurations can be used, DRX-Config-1 with a periodicity at 1/60 Hz, targeting DL & UL video streams, and DRX-Config-2 with a periodicity at 1/100 Hz, targeting DL & UL audio/data streams.

As can be seen above, various solutions for simultaneous DRX configurations have been discussed. As another main aspect of the present disclosure, details regarding HARQ timer enhancement will be shown below.

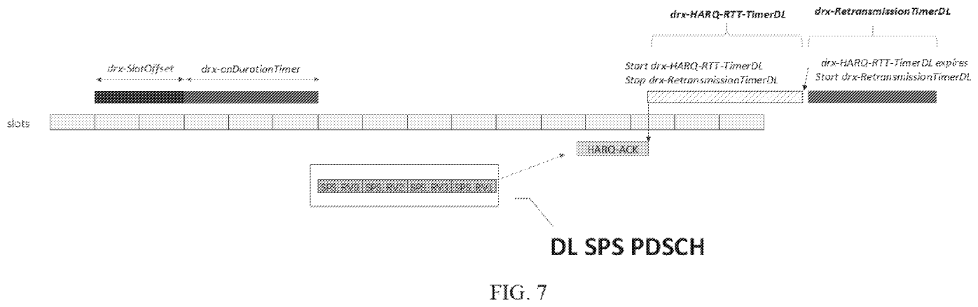

In the current DRX design, two timers are set for each DL HARQ process, regulating when the UE needs to monitor PDCCH scheduling DL traffic (for HARQ transmission and retransmission), the initial values are according to two parameters configured in DRX-Config: drx-HARQ-RTT-TimerDL and drx-RetransmissionTimerDL. FIG. 7 illustrates an example timeline for drx-HARQ-RTT-TimerDL and drx-RetransmissionTimerDL. Note the first timer establishes the visibility to the UE: retransmission of the transport block won't come earlier than the value derived from that. The second timer establishes the visibility to the UE on when to stop PDCCH monitoring regarding the current transport block's reception: after the time derived from that, retransmission won't happen.

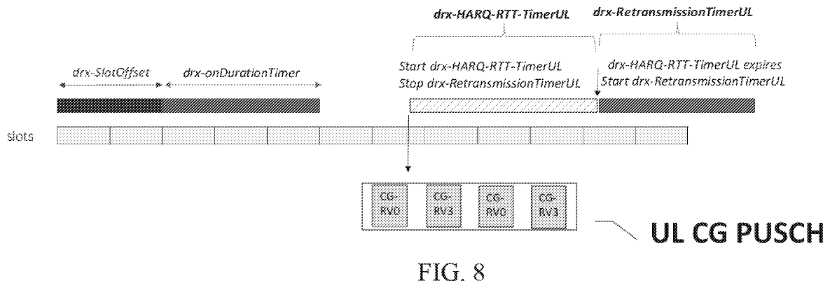

Two other timers are configured for each UL HARQ process, regulating when the UE needs to monitor PDCCH scheduling UL traffic (for HARQ transmission and retransmission), the initial values are according to two parameters configured in DRX-Config: drx-HARQ-RTT-TimerUL and drx-RetransmissionTimerUL. FIG. 8 illustrates an example timeline for drx-HARQ-RTT-Timer UL and drx-RetransmissionTimerUL. Note the first timer establishes the visibility to the UE: retransmission of the transport block won't come earlier than the value derived from that. The second timer establishes the visibility to the UE on when to stop PDCCH monitoring regarding the current transport block's retransmission: after the time derived from that, retransmission won't happen.

According to some embodiments, traffic flow-specific timers are introduced to save power. For a DL scenario, instead of using a common timer value for all HARQ processes, Semi-Persistent Scheduling (SPS)-specific timer values are supported. The first control information includes a SPS configuration. The SPS configuration specifies one or more parameters for a corresponding HARQ process identifying at least one DL retransmission scheduling PDCCH monitoring period, and the one or more parameters includes a drx-HARQ-RTT-Timer DL and a drx-Retransmission TimerDL.

According to some embodiments, from the formula provided in TS38.321, the HARQ process ID or HARQ process number for a SPS occasion can be calculated, then a HARQ-ID specific timer can be maintained by the UE.

According to some embodiments, for a flow with stringent latency requirement (e.g., 10 ms), if Time Division Duplex (TDD) is used, the opportunities for retransmission may be limited. If a packet with the data flow is carried over SPS configuration, no retransmission is realistically possible. For such a SPS configuration, PDCCH monitoring for retransmission is a waste of power, thus a single transmission is expected. There can be a few ways to configure the timer to let the UE know that it does not need to monitor for retransmission:
drx-HARQ-RTT-TimerDL=a huge number for that SPS configuration, e.g., infinity
drx-HARQ-RTT-TimerDL=drx-RetransmissionTimerDL, so that the UE knows it does not need to monitor for the retransmission
drx-RetransmissionTimerDL=0
drx-HARQ-RTT-TimerDL=drx-RetransmissionTimerDL=0
define a special state for drx-RetransmissionTimerDL and/or drx-HARQ-RTT-TimerDL, which means the UE does not need to monitor PDCCH scheduling a retransmission, additionally the UE may even skip HARQ ACK transmission.

It is understandable that if the latency is very stringent then a small drx-HARQ-RTT-TimerDL value is employed. Then in an extreme case a small value can also be zero. For this very specific case of a zero-timer value, it is agreed to treat the timer as immediately expired. TS38.321: “When the MAC entity applies zero value for a timer, the timer shall be started and immediately expire unless explicitly stated otherwise.” In some embodiments, a timer value of zero might as well apply if no retransmission is expected. In other embodiments, a value of “infinity” is introduced to explicitly indicate that retransmissions are not expected and/or the drx-HARQ-RTT-TimerDL timer is disabled.

According to some embodiments, some data flow may have more relaxed latency requirements (e.g., 30 ms), hence opportunities for retransmission may be abundant. HARQ retransmission may help improve system capacity. In this case, setting drx-RetransmissionTimerDL to a large value is reasonable.

According to some embodiments, for low priority and latency insensitive traffic, the network can give more processing time to UE. In this case, setting drx-HARQ-RTT-Timer DL large can give the UE more processing to process Physical Downlink Shared Channel (PDSCH), e.g., Code Block Group (CBG) based with a huge transport block.

According to some embodiments, for SPS retransmission, the one or more parameters of the corresponding HARQ process is set according to one of:
For SPS dynamic retransmission (scheduled by PDCCH masked by Configured Scheduling-Radio Network Temporary Identity (CS-RNTI)), then parameters in the common configurations as in DRX are used for that HARQ process
For SPS dynamic retransmission (scheduled by PDCCH masked by CS-RNTI), then parameters in the SPS-config specific configurations are used for that HARQ process.

According to some embodiments, once a HARQ process is used by dynamic signaling (PDCCH not masked by CS-RNTI), then the common parameters in DRX config are used.

According to some embodiments, at S204, monitoring PDCCH based on the at least one DL retransmission scheduling PDCCH monitoring period.

According to some embodiments, the first control information includes a Configured Grant (CG) configuration. The CG configuration specifies one or more parameters for a corresponding HARQ process identifying at least one UL retransmission scheduling PDCCH monitoring period. The one or more parameters include drx-HARQ-RTT-TimerUL and drx-RetransmissionTimerUL.

According to some embodiments, from the formula provided in TS38.321, the HARQ process ID or the HARQ process number for a CG occasion can be calculated, then a HARQ-ID specific timer can be maintained by the UE.

According to some embodiments, some data flows may have stringent latency requirement such as pose/control for uplink. One characteristic with pose/control is that its frequency is large (250 Hz), but reliability requirement is rather loose. Given the user's movement would not be very abrupt, interpolation of the UE's pose and trajectory is possible at the application server if some packets for pose/control are lost. In this case, for pose/control, transmission the packet once is enough. There can be a few ways to configure the timer to let the UE know that it does not need to monitor for retransmission:
drx-HARQ-RTT-Timer UL=a huge number for that CG configuration, e.g., infinity
drx-HARQ-RTT-TimerUL=drx-RetransmissionTimerUL, so that the UE knows it does not need to monitor for the retransmission
drx-RetransmissionTimerUL=0
drx-HARQ-RTT-TimerUL=drx-RetransmissionTimerUL=0
define a special state for drx-RetransmissionTimerUL and/or drx-HARQ-RTT-Timer UL, which means the UE does not need to monitor PDCCH scheduling a retransmission

It is understandable that if the latency is very stringent then a small drx-HARQ-RTT-Timer UL value is employed. Then in an extreme case, a small value can also be zero. In some embodiments, a timer value of zero might as well apply if no retransmission is expected. In other embodiments, a value of “infinity” is introduced to explicitly indicate that retransmissions are not expected and/or the drx-HARQ-RTT-Timer UL timer is disabled.

According to some embodiments, for CG retransmission, the one or more parameters of the corresponding HARQ process are set according to one selected from a group consisting of:
For CG dynamic retransmission (scheduled by PDCCH masked by Configured Scheduling-Radio Network Temporary Identity (CS-RNTI)), then parameters in the common configurations as in DRX are used for that HARQ process
For CG dynamic retransmission (scheduled by PDCCH masked by CS-RNTI), then parameters in the CG-config specific configurations are used for that HARQ process.

According to some embodiments, once a HARQ process is used by dynamic signaling (PDCCH not masked by CS-RNTI), then the common parameters in DRX config are used.

According to some embodiments, at S204, monitoring PDCCH based on the at least one UL retransmission scheduling PDCCH monitoring period.

According to some embodiments, the first control information includes a plurality of parameter value sets for one or more parameters identifying at least one retransmission scheduling PDCCH monitoring period. It is understandable that the plurality of parameter value sets may be generated according to rules discussed above.

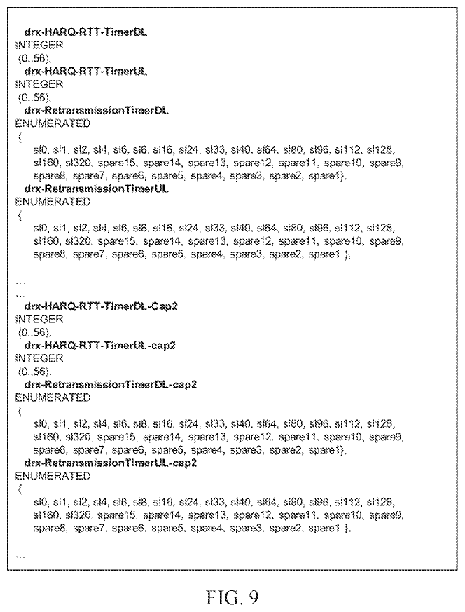

According to some embodiments, for each processing time corresponding to different UE capabilities, parameters parallel to those in the current DRX config are introduced. In an exemplary embodiment, four HARQ related timers associated with each of two UE capabilities, Cap #1 and Cap #2, are shown in FIG. 9. For UE processing time, the processing time difference between Cap #1 and Cap #2 is Sub-Carrier Space (SCS) dependent. Hence potentially cell-dependent parameters can be introduced for a cell or for a Band Width Parts (BWP). When it is configured for a BWP, the parameters can be included under “BWP-Downlink,” for example. For the purpose of illustration, Cap #2 has a greater processing capability than Cap #1. It is understandable that those skilled in the art may set Cap #1 and Cap #2 with different capabilities according to their requirements, and is not limited in here.

According to some embodiments, for timer value determination for a PDSCH, the plurality of parameter value sets includes a first parameter value set and a second parameter value set. The first and second parameter value set corresponds to Cap #1 and Cap #2, respectively. The method may further include: determining using the first parameter value set or the second parameter value set based on a DCI from the network device. In this way, the timer value may be determined based on the UE processing time, and a greater capability leads to shorter processing time, and a higher priority for the network device if a shorter turnaround time is expected by the network device.

According to some embodiments, on a CC configured with Cap #2 PDSCH processing, one of the following alternatives can be used:
if (DG) scheduled or (SPS) activated by DCI 1_0, then Cap #1 and its associated timer values are used
if (DG) scheduled or (SPS) activated by DCI 1_0, and only front-load Demodulation Reference Signal (DMRS) is used, then Cap #2 and its associated timer value are used: otherwise Cap #1 and its associated timer values are used.

Comparing to front load and additional DMRS, front load DMRS facilitates the UE to estimate the channel and perform receiving detection quickly, thus being associated with greater UE capability is reasonable

According to some embodiments, in a case where the PDSCH is a dynamic grant scheduled by a scheduling DCI, the timer value(s) is able to be determined by the DCI. And in a case where the UE is configured with an SPS configuration, the SPS configuration may be activated by a DCI, and the timer value(s) for a HARQ process ID for SPS configuration is able to be determined by the DCI. In this way, for both DG PUSCH and SPS PUSCH, the timer value(s) is able to be determined by the DCI.

According to some embodiments, for timer value determination for a PUSCH (DG PUSCH, Type 1 CG PUSCH, or Type 2 CG PUSCH), the determination is based on the high layer parameter processingType2Enabled in PUSCH-ServingCellConfig.

According to some embodiments, if the parameter processingType2Enabled is configured for the cell and set to enable, then Cap #2 PUSCH processing is assumed and corresponding timer values are assumed; otherwise Cap #1 PUSCH processing is assumed and corresponding timer values are assumed.

According to some embodiments, different drx-HARQ-RTT-TimerUL timer and drx-RetransmissionTimerUL timer based on the different physical layer resource allocations, e.g., different PUSCH/PDSCH duration, different SCS, different cell, different BWP, etc., are introduced. This is applicable on both SPS/CG and DG scheduling, for both UL and DL. UE needs to select the parameter based on the scheduling DCI or activation DCI.

According to some embodiments, the HARQ related timer values are selectable through dynamic signaling. The method may further include: obtaining an eighth control information from the network device. The eighth control information indicates a target parameter value set from the plurality of parameter value sets. In this way, the UE may store multiple timer value sets transmitted over the first control information, expanding the range of options in determining timer values.

According to some embodiments, the first control information is transmitted via RRC signaling, so that the plurality of parameter value sets is stored in the UE, e.g., associated with each node states, or different physical layer priority, etc.

According to some embodiments, the eighth control information is transmitted via dynamic signaling of a DCI, and a plurality of code states of the DCI corresponds to the plurality of parameter value sets, respectively. In an exemplary embodiment, code state 1 in DCI triggers the use of a first set of HARQ related timer values for the HARQ process ID associated with the PDSCH; code state 2 in DCI triggers the use of a second set of HARQ related timer values for the HARQ process ID associated with the PDSCH. A similar design can be used for uplink.

According to some embodiments, the eighth control information is transmitted via dynamic signaling of a DCI and a MAC CE, the MAC CE specifies a portion of the plurality of parameter value sets, and each code state of the DCI corresponds to a parameter value set in the portion of the plurality of parameter value sets. In an exemplary embodiment, many parameter value sets are stored in the UE, and the MAC CE specifies one or two sets, then DCI may trigger one of them for use.

According to some embodiments, the eighth control information is transmitted via a physical layer priority, and the physical layer priority specific parameter value sets are configured at the UE by the network.

According to some embodiments, the HARQ related timer values are determined semi-statically through CCs. In some embodiments, a first set is used for PDSCHs or their associated HARQ process IDs over CC1/CC2, a second set is used for PDSCHs or their associated HARQ process IDs over CC3/CC4. In an exemplary embodiment, CC1/CC2 is on frequency range 1 (FR1), CC3/CC4 is on FR2, the network device can decide to use each frequency range/band for suitable data transmission, e.g., high reliability and low data rate vs lower reliability and high data rate. In this way, a linkage between a data flow/traffic pattern and CCs/bands/FRs can be established, thus the timer values may be determined through CCs/bands/FRs. A similar design can be used for uplink.

In another exemplary embodiment, CC1/CC2 are associated with Cap #2 PDSCH processing, and CC3/CC4 are associated with Cap #1 PDSCH processing, and this may avoid the differentiation of Cap #1 and Cap #2 transmissions on the same CC, and may also avoid potential issues raised by DCI formats. A similar design can be used for uplink.

According to some embodiments, the HARQ related timer values are determined according to HARQ process ID subsets. In an exemplary embodiment, on CC1, HARQ processing IDs are partitioned into two groups: {0-11}, {12-15}, group 1 is associated with a first timer value set, group 2 is associated with a second timer value set. In this way, it is compatible with enhanced Type 3 codebook feedback. A similar design can be used for uplink.

According to some embodiments, the HARQ related timer values are determined according to DCI formats. In an exemplary embodiment, DCI format 1_0/0_0 always uses the DRX-Config, other DCI formats, such as 1_1 or 0_1 (or 1_2 or 0_2) are available for use according to embodiments above. In this way, a robust fallback behavior is preserved in case that UE's operation with other DCI formats may encounter any issue.

According to some embodiments, parameter cg-RetransmissionTimer is introduced: the duration after a configured grant (re)transmission of a HARQ process when the UE shall not autonomously retransmit that HARQ process. In some embodiments, cg-RetransmissionTimer could be set to large value, i.e., effectively disable UE autonomous retransmission, so that only DG retransmission is allowed in order to meet delay bound of XR. In some other embodiments, the data over that particular CG configuration is delay-insensitive, then effectively disabling retransmission.

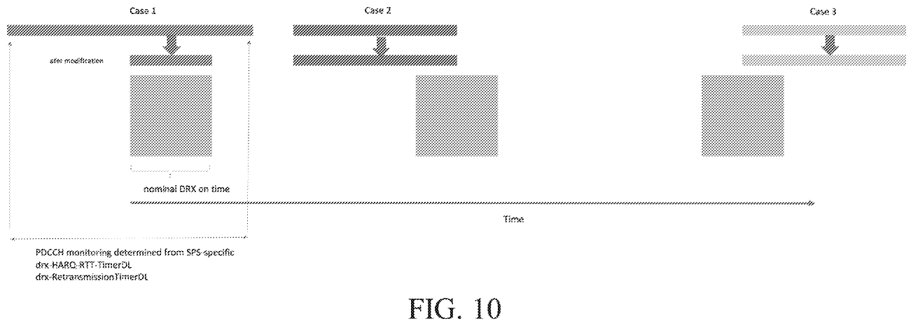

According to some embodiments, a PDCCH monitoring period due to non-common parameters partially overlaps with or fully encloses a DRX On period, as is shown in FIG. 10. In some embodiment, as is shown in FIG. 10 as Case 1, if the PDCCH monitoring duration fully encloses the DRX On period, the PDCCH monitoring duration determined for the current HARQ ID is shrunken to the DRX On period. It is understandable that this may happen when control capacity and system capacity for data transmission is not an issue. In this way, the UE can save more power by skipping some PDCCH monitoring occasions. In some other embodiments, as is shown in FIG. as Case 2 and Case 3, if the PDCCH does not fully enclose the DRX On period, the original PDCCH monitoring duration is kept.

According to some embodiments, If UL skipping with CG is used, since the HARQ process is not consumed by CG, then the flow-specific or CG-specific configuration is not used, for both CG PUSCH and DG PUSCH.

According to some embodiments, If DL skipping is used (the network device does not send data to the UE), and the UE determines there is no valid transmission from the network device through some means, such as a UE implementation specific method, notification from an embedded control signaling, etc., the UE does not start timers according to either the SPS-specific configuration or the DRX configuration, for both SPS PDSCH (initial transmission) and/or DG PDSCH.

Following is an exemplary embodiment for HARQ timer enhancement. In an exemplary embodiment, In the AR UL traffic model, there can be a video stream (60 Hz), audio/data stream (100 Hz), and pose/control stream (250 Hz). In the AR DL traffic model, there can be a video stream (60 Hz), audio/data stream (100 Hz). A single DRX configuration at 60 Hz is configured, targeting DL & UL video streams. Configuring one CG configuration with a periodicity at 1/100 Hz, targeting UL audio/data streams. With a large drx-HARQ-RTT-Timer UL, depending where the CG starts, its retransmission can be mostly likely triggered by PDCCH within the nominal DRX On period (CG specific drx-HARQ-RTT-TimerUL is chosen according audio/data stream's delay bound). Configuring another CG configuration with a periodicity at 1/250 Hz, targeting pose/control stream. With drx-RetransmissionTimerUL=0 for the CG-specific parameters. Configuring one SPS configuration with a periodicity at 1/100 Hz, targeting UL audio/data streams. With a large drx-HARQ-RTT-TimerDL, so depending where the SPS starts, its retransmission can be mostly likely triggered by PDCCH within the nominal DRX On period (SPS specific drx-HARQ-RTT-TimerDL is chosen according audio/data stream's delay bound).

Following is an exemplary embodiment for a combination of simultaneous DRX configurations and HARQ timer enhancement. In an exemplary embodiment, In the AR UL traffic model, there can be a video stream (60 Hz), audio/data stream (100 Hz), and pose/control stream (250 Hz). In the AR DL traffic model, there can be a video stream (60 Hz), audio/data stream (100 Hz). Two simultaneous DRX configurations can be used, DRX-Config-1 with a periodicity at 1/60 Hz, targeting DL & UL video streams, and DRX-Config-2 with a periodicity at 1/100 Hz, targeting DL & UL audio/data streams. Configuring one CG configuration with a periodicity at 1/250 Hz, targeting pose/control stream. With drx-RetransmissionTimerUL=0 to disable retransmission.

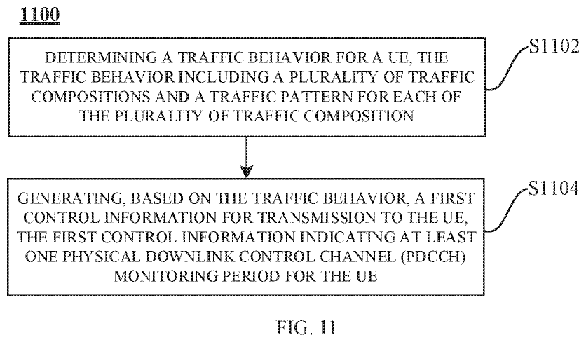

FIG. 11 illustrates a flowchart for an exemplary method for a network device in accordance with some embodiments. The method 1100 illustrated in FIG. 11 may be implemented by the base station 150 described in FIG. 1. For example, the network device may be the network device of the base station 150.

In some embodiments, the method 1100 for a network device may include the following steps: S1102, determining a traffic behavior for a UE, the traffic behavior including a plurality of traffic compositions and a traffic pattern for each of the plurality of traffic composition; and S1104, generating, based on the traffic behavior, a first control information for transmission to the UE, the first control information indicating at least one physical downlink control channel (PDCCH) monitoring period for the UE.

According to some embodiments, a plurality of DRX configurations transmitted to the UE over the first control information can be configured simultaneously to handle multiple data flows, and each of the plurality of DRX configurations may indicate at least one DRX On period based on the corresponding DRX-Config parameters

According to some embodiments, the method may further include: generating a third control information for transmission to the UE. The third control information causes the UE to perform at least one operation selected from a group consisting of: modification of at least one DRX configuration of the plurality of DRX configurations; addition of at least one DRX configuration to the plurality of DRX configurations; and removal of at least one DRX configuration from the plurality of DRX configurations. In this way, the network device is able to modify the “configured set”.

According to some embodiments, the third control information is transmitted via an RRC signaling message, thus the “configured set” is configured by a RRC configuration.

According to some embodiments, the method may further include: generating a second control information for transmission to the UE, where the second control information causes the UE to perform at least one operation selected from a group consisting of: activation of at least one DRX configuration of the plurality of DRX configurations; and deactivation of at least one DRX configuration of activated DRX configurations. In this way, the network device is able to modify the “active set.”

According to some embodiments, the third control information is transmitted via an RRC signaling message, thus the “active set” is also configured by a RRC configuration. It is understandable that any operation to the “active set” should be constrained with the “configured set”.

However, RRC configurations may raise an issue of causing an ambiguity period between the UE and the network device. According to some embodiments, the third control information is transmitted via a MAC CE, thus the “active set” is configured by the MAC CE. Further, a corresponding taking effect time is set to overcome this ambiguity issue.

According to some embodiments, the DRX adaption can be achieved by dynamical signaling. The first control information includes a plurality of DRX configuration sets. Each of the plurality of DRX configuration sets includes at least one DRX configuration, and each of the at least one DRX configuration indicates at least one DRX On period. The method may further include: generating a fourth control information for transmission to the UE. The fourth control information indicates a target DRX configuration set from the plurality of DRX configuration sets. In this way, the UE may store multiple DRX configuration sets transmitted over the first control information, and each set includes one or more preset DRX configurations that are bound to be activated or deactivated simultaneously.

According to some embodiments, the fourth control information is transmitted via dynamic signaling of a Downlink Control Information (DCI), and a plurality of code states of the DCI corresponds to the plurality of DRX configuration sets, respectively.

According to some embodiments, a single WUS configuration can be configured for all DRX configurations. The method may further include generating a fifth control information for transmission to the UE. The fifth control information includes a WUS configuration indicating at least one wake-up period associated with the respective at least one DRX On period indicated by each of the plurality of DRX configurations. If a portion of window defined by ps-Offset and minimum time gap value relative to the start time of drx-onDurationTimer of one DRX configuration overlaps with the DRX On time of another DRX configuration, then the UE does not monitor the WUS during the portion of the window. The portion of the window can the whole of the window.

Since different data flows can have different jitters, to use different WUSs for different data flows can be also motivated. With that, there can be multiple WUS configurations, e.g., with ps-offset 1, ps-offset 2, etc., with respect to different data flows. According to some embodiments, the method may further include generating a sixth control information for transmission to the UE. The sixth control information includes a plurality of WUS configurations corresponding to the plurality of traffic compositions, respectively. The plurality of WUS configuration indicates at least one wake-up period associated with the at least one PDCCH monitoring period.

A linkage can be created between a DRX configuration and a corresponding WUS configuration. If 1-1 mapping is established, then the maintenance of the “active set” of DRX configurations can be naturally used for WUS configurations maintenance. According to some embodiments, the method may further include generating a seventh control information from the network device. The seventh control information includes a plurality of WUS configurations corresponding to the plurality of DRX configurations, respectively, and each of the plurality of WUS configuration indicates at least one wake-up period associated with at least one DRX On period indicated by a corresponding DRX configurations.

According to some embodiments, the first control information includes a Semi-Persistent Scheduling (SPS) configuration. The SPS configuration specifies one or more parameters for a corresponding HARQ process identifying at least one DL retransmission scheduling PDCCH monitoring period, and the one or more parameters comprise a drx-HARQ-RTT-Timer DL and a drx-Retransmission TimerDL.

According to some embodiments, for a flow with stringent latency requirement (e.g., 10 ms), if Time Division Duplex (TDD) is used, the opportunities for retransmission may be limited. If a packet with the data flow is carried over SPS configuration, no retransmission is realistically possible. For such a SPS configuration, PDCCH monitoring for retransmission is a waste of power, thus a single transmission is expected. There can be a few ways to configure the timer to let the UE know that it does not need to monitor for retransmission:
drx-HARQ-RTT-TimerDL=a huge number for that SPS configuration, e.g., infinity
drx-HARQ-RTT-TimerDL=drx-RetransmissionTimerDL, so that the UE knows it does not need to monitor for the retransmission
drx-RetransmissionTimerDL=0
drx-HARQ-RTT-TimerDL=drx-RetransmissionTimerDL=0
define a special state for drx-RetransmissionTimerDL and/or drx-HARQ-RTT-TimerDL, which means the UE does not need to monitor PDCCH scheduling a retransmission, additionally the UE may even skip HARQ ACK transmission.

It is understandable that if the latency is very stringent then a small drx-HARQ-RTT-TimerDL value is employed. Then in an extreme case a small value can also be zero. For this very specific case of a zero-timer value, it is agreed to treat the timer as immediately expired. TS38.321: “When the MAC entity applies zero value for a timer, the timer shall be started and immediately expire unless explicitly stated otherwise.” In some embodiments, a timer value of zero might as well apply if no retransmission is expected. In other embodiments, a value of “infinity” is introduced to explicitly indicate that retransmissions are not expected and/or the drx-HARQ-RTT-TimerDL timer is disabled.

According to some embodiments, some data flow may have more relaxed latency requirements (e.g., 30 ms), hence opportunities for retransmission may be abundant. HARQ retransmission may help to improve system capacity. In this case, setting drx-RetransmissionTimerDL to a large value is reasonable.

According to some embodiments, for low priority and latency insensitive traffic, the network can give more processing time to UE. In this case, setting drx-HARQ-RTT-Timer DL large can give the UE more processing to process Physical Downlink Shared Channel (PDSCH), e.g., Code Block Group (CBG) based with a huge transport block.

According to some embodiments, the first control information includes a Configured Grant (CG) configuration. The CG configuration specifies one or more parameters for a corresponding HARQ process identifying at least one UL retransmission scheduling PDCCH monitoring period. The one or more parameters include drx-HARQ-RTT-Timer UL and drx-RetransmissionTimerUL.

According to some embodiments, from the formula provided in TS38.321, the HARQ process ID for a CG occasion can be calculated, then a HARQ-ID specific timer can be maintained by the UE.

According to some embodiments, some data flow may have stringent latency requirement, such as pose/control for uplink. One characteristic with pose/control is its frequency is large (250 Hz), but reliability requirement is rather loose. Given the user's movement would not be very abrupt, interpolation of the UE's pose and trajectory is possible at the application server if some packets for pose/control are lost. In this case, for pose/control, transmission the packet once is enough. There can be a few ways to configure the timer to let the UE know that it does not need to monitor for retransmission:
drx-HARQ-RTT-Timer UL=a huge number for that CG configuration, e.g., infinity
drx-HARQ-RTT-TimerUL=drx-RetransmissionTimerUL, so that the UE knows it does not need to monitor for the retransmission
drx-RetransmissionTimerUL=0
drx-HARQ-RTT-TimerUL=drx-RetransmissionTimerUL=0
define a special state for drx-RetransmissionTimerUL and/or drx-HARQ-RTT-TimerUL, which means the UE does not need to monitor PDCCH scheduling a retransmission

It is understandable that if the latency is very stringent then a small drx-HARQ-RTT-Timer UL value is employed. Then in an extreme case a small value can also be zero. In some embodiments, a timer value of zero might as well apply if no retransmission is expected. In other embodiments, a value of “infinity” is introduced to explicitly indicate that retransmissions are not expected and/or the drx-HARQ-RTT-Timer UL timer is disabled.

According to some embodiments, in a case where HARQ related timer values determined by DCI, MAC CE, and/or physical layer priority, the method may further include generating an eighth control information for transmission to the UE. The eighth control information indicates a parameter value set for one or more parameters identifying at least one retransmission scheduling PDCCH monitoring period. The eighth control information is transmitted via at least one of a DCI and a MAC CE. The physical layer priority may be indicated in the eighth control information.

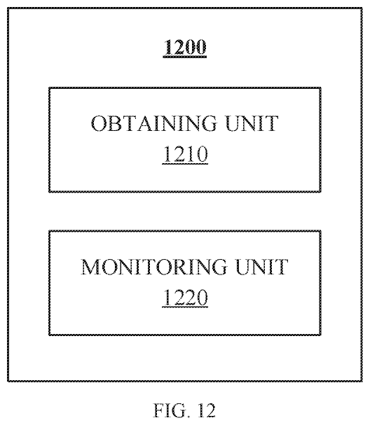

FIG. 12 illustrates an exemplary block diagram of an apparatus for a user equipment (UE), in accordance with some embodiments. The apparatus 1200 illustrated in FIG. 12 may be used to implement the method 200 as illustrated in combination with FIG. 2.

As illustrated in FIG. 12, the apparatus 1200 includes an obtaining unit 1210 and a monitoring unit 1220.

The obtaining unit 1210 may be configured to obtain a first control information from a network device, where the first control information indicates at least one physical downlink control channel (PDCCH) monitoring period for the UE.

The monitoring unit 1220 may be configured to monitor PDCCH based on the at least one PDCCH monitoring period.

According to the embodiments of the present application, UE monitor PDCCH based on the determined at least one PDCCH monitoring period to facilitate UE power saving.

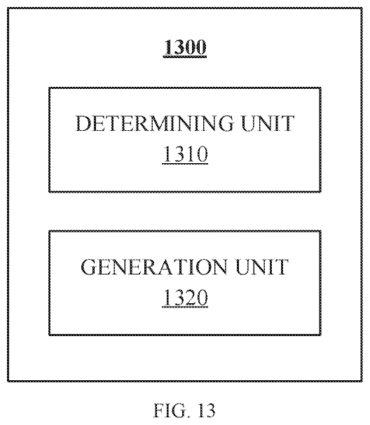

FIG. 13 illustrates an exemplary block diagram of an apparatus for a network device in accordance with some embodiments. The apparatus 1300 illustrated in FIG. 13 may be used to implement the method 1100 as illustrated in combination with FIG. 11.

As illustrated in FIG. 13, the apparatus 1300 includes a determining unit 1310 and a generation unit 1320.

The determining unit 1310 may be configured to determine a traffic behavior for a UE, where the traffic behavior includes a plurality of traffic compositions and a traffic pattern for each of the plurality of traffic composition

The generation unit 1320 may be configured to generate a first control information for transmission to the UE based on the traffic behavior, where the first control information indicates at least one physical downlink control channel (PDCCH) monitoring period for the UE.

According to the embodiments of the present application, UE monitor PDCCH based on the determined at least one PDCCH monitoring period to facilitate UE power saving.

In some embodiments, also provided is an apparatus for a user equipment (UE), the apparatus comprising: one or more processors configured to perform steps of any of the methods for UE according to various embodiments of the disclosure. In some embodiments, also provided is an apparatus of a network device, the apparatus comprising: one or more processors configured to perform steps of any of the methods for network device according to various embodiments of the disclosure. In some embodiments, also provided is a computer-readable medium having computer programs stored thereon which, when executed by one or more processors, cause an apparatus to perform steps of any of the methods according to various embodiments of the disclosure. In some embodiments, also provided is an apparatus for a communication device, comprising means for performing steps of any of the methods according to various embodiments of the disclosure. In some embodiments, also provided is a computer program product comprising computer programs which, when executed by one or more processors, cause an apparatus to perform steps of any of the methods according to various embodiments of the disclosure.

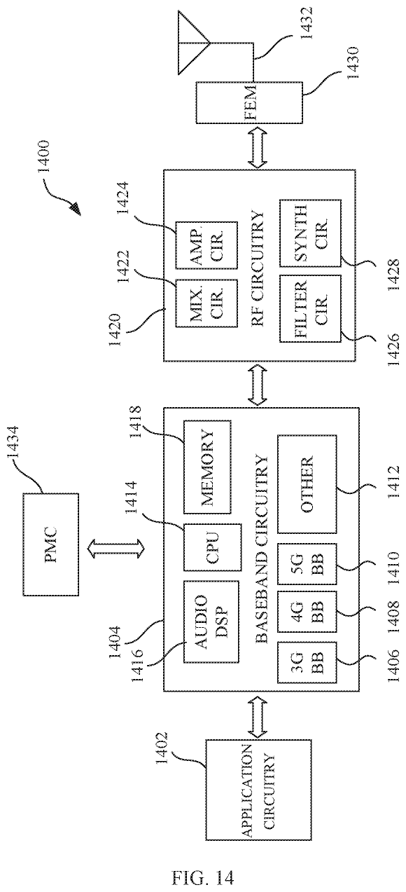

FIG. 14 illustrates example components of a device 1400 in accordance with some embodiments. In some embodiments, the device 1400 may include application circuitry 1402, baseband circuitry 1404, Radio Frequency (RF) circuitry (shown as RF circuitry 1420), front-end module (FEM) circuitry (shown as FEM circuitry 1430), one or more antennas 1432, and power management circuitry (PMC) (shown as PMC 1434) coupled together at least as shown. The components of the illustrated device 1400 may be included in a UE or a RAN node. In some embodiments, the device 1400 may include fewer elements (e.g., a RAN node may not utilize application circuitry 1402, and instead include a processor/controller to process IP data received from an EPC). In some embodiments, the device 1400 may include additional elements, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1402 may include one or more application processors. For example, the application circuitry 1402 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1400. In some embodiments, processors of application circuitry 1402 may process IP data packets received from an EPC.

The baseband circuitry 1404 may include circuitry such as, but not limited to, one or more single-core or multi-core processors. The baseband circuitry 1404 may include one or more baseband processors or control logic to process baseband signals received from a receive signal path of the RF circuitry 1420 and to generate baseband signals for a transmit signal path of the RF circuitry 1420. The baseband circuitry 1404 may interface with the application circuitry 1402 for generation and processing of the baseband signals and for controlling operations of the RF circuitry 1420. For example, in some embodiments, the baseband circuitry 1404 may include a third generation (3G) baseband processor (3G baseband processor 1406), a fourth generation (4G) baseband processor (4G baseband processor 1408), a fifth generation (5G) baseband processor (5G baseband processor 1410), or other baseband processor(s) 1412 for other existing generations, generations in development or to be developed in the future (e.g., second generation (2G), sixth generation (6G), etc.). The baseband circuitry 1404 (e.g., one or more of baseband processors) may handle various radio control functions that enable communication with one or more radio networks via the RF circuitry 1420. In other embodiments, some or all of the functionality of the illustrated baseband processors may be included in modules stored in the memory 1418 and executed via a Central Processing ETnit (CPET 1414). The radio control functions may include, but are not limited to, signal modulation/demodulation, encoding/decoding, radio frequency shifting, etc. In some embodiments, modulation/demodulation circuitry of the baseband circuitry 1404 may include Fast-Fourier Transform (FFT), precoding, or constellation mapping/demapping functionality. In some embodiments, encoding/decoding circuitry of the baseband circuitry 1404 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1404 may include a digital signal processor (DSP), such as one or more audio DSP(s) 1416. The one or more audio DSP(s) 1416 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1404 and the application circuitry 1402 may be implemented together, for example, on a system on a chip (SOC).

In some embodiments, the baseband circuitry 1404 may provide for communication compatible with one or more radio technologies. For example, in some embodiments, the baseband circuitry 1404 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1404 is configured to support radio communications of more than one wireless protocol may be referred to as multi-mode baseband circuitry.

The RF circuitry 1420 may enable communication with wireless networks using modulated electromagnetic radiation through a non-solid medium. In various embodiments, the RF circuitry 1420 may include switches, filters, amplifiers, etc., to facilitate the communication with the wireless network. The RF circuitry 1420 may include a receive signal path which may include circuitry to down-convert RF signals received from the FEM circuitry 1430 and provide baseband signals to the baseband circuitry 1404. The RF circuitry 1420 may also include a transmit signal path which may include circuitry to up-convert baseband signals provided by the baseband circuitry 1404 and provide RF output signals to the FEM circuitry 1430 for transmission.

In some embodiments, the receive signal path of the RF circuitry 1420 may include mixer circuitry 1422, amplifier circuitry 1424 and filter circuitry 1426. In some embodiments, the transmit signal path of the RF circuitry 1420 may include filter circuitry 1426 and mixer circuitry 1422. The RF circuitry 1420 may also include synthesizer circuitry 1428 for synthesizing a frequency for use by the mixer circuitry 1422 of the receive signal path and the transmit signal path. In some embodiments, the mixer circuitry 1422 of the receive signal path may be configured to down-convert RF signals received from the FEM circuitry 1430 based on the synthesized frequency provided by synthesizer circuitry 1428. The amplifier circuitry 1424 may be configured to amplify the down-converted signals and the filter circuitry 1426 may be a low-pass filter (LPF) or band-pass filter (BPF) configured to remove unwanted signals from the down-converted signals to generate output baseband signals. Output baseband signals may be provided to the baseband circuitry 1404 for further processing. In some embodiments, the output baseband signals may be zero-frequency baseband signals, although this is not a requirement. In some embodiments, the mixer circuitry 1422 of the receive signal path may include passive mixers, although the scope of the embodiments is not limited in this respect.

In some embodiments, the mixer circuitry 1422 of the transmit signal path may be configured to up-convert input baseband signals based on the synthesized frequency provided by the synthesizer circuitry 1428 to generate RF output signals for the FEM circuitry 1430. The baseband signals may be provided by the baseband circuitry 1404 and may be filtered by the filter circuitry 1426.

In some embodiments, the mixer circuitry 1422 of the receive signal path and the mixer circuitry 1422 of the transmit signal path may include two or more mixers and may be arranged for quadrature downconversion and upconversion, respectively. In some embodiments, the mixer circuitry 1422 of the receive signal path and the mixer circuitry 1422 of the transmit signal path may include two or more mixers and may be arranged for image rejection (e.g., Hartley image rejection). In some embodiments, the mixer circuitry 1422 of the receive signal path and the mixer circuitry 1422 may be arranged for direct downconversion and direct upconversion, respectively. In some embodiments, the mixer circuitry 1422 of the receive signal path and the mixer circuitry 1422 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1420 may include analog-to-digital converter (ADC) and digital-to-analog converter (DAC) circuitry and the baseband circuitry 1404 may include a digital baseband interface to communicate with the RF circuitry 1420.

In some dual-mode embodiments, a separate radio IC circuitry may be provided for processing signals for each spectrum, although the scope of the embodiments is not limited in this respect.

In some embodiments, the synthesizer circuitry 1428 may be a fractional −N synthesizer or a fractional N/N+1 synthesizer, although the scope of the embodiments is not limited in this respect as other types of frequency synthesizers may be suitable. For example, synthesizer circuitry 1428 may be a delta-sigma synthesizer, a frequency multiplier, or a synthesizer including a phase-locked loop with a frequency divider.

The synthesizer circuitry 1428 may be configured to synthesize an output frequency for use by the mixer circuitry 1422 of the RF circuitry 1420 based on a frequency input and a divider control input. In some embodiments, the synthesizer circuitry 1428 may be a fractional N/N+1 synthesizer.

In some embodiments, frequency input may be provided by a voltage controlled oscillator (VCO), although that is not a requirement. Divider control input may be provided by either the baseband circuitry 1404 or the application circuitry 1402 (such as an applications processor) depending on the desired output frequency. In some embodiments, a divider control input (e.g., N) may be determined from a look-up table based on a channel indicated by the application circuitry 1402.

Synthesizer circuitry 1428 of the RF circuitry 1420 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1428 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1420 may include an IQ/polar converter.

The FEM circuitry 1430 may include a receive signal path which may include circuitry configured to operate on RF signals received from one or more antennas 1432, amplify the received signals and provide the amplified versions of the received signals to the RF circuitry 1420 for further processing. The FEM circuitry 1430 may also include a transmit signal path which may include circuitry configured to amplify signals for transmission provided by the RF circuitry 1420 for transmission by one or more of the one or more antennas 1432. In various embodiments, the amplification through the transmit or receive signal paths may be done solely in the RF circuitry 1420, solely in the FEM circuitry 1430, or in both the RF circuitry 1420 and the FEM circuitry 1430.

In some embodiments, the FEM circuitry 1430 may include a TX/RX switch to switch between transmit mode and receive mode operation. The FEM circuitry 1430 may include a receive signal path and a transmit signal path. The receive signal path of the FEM circuitry 1430 may include an LNA to amplify received RF signals and provide the amplified received RF signals as an output (e.g., to the RF circuitry 1420). The transmit signal path of the FEM circuitry 1430 may include a power amplifier (PA) to amplify input RF signals (e.g., provided by the RF circuitry 1420), and one or more filters to generate RF signals for subsequent transmission (e.g., by one or more of the one or more antennas 1432).

In some embodiments, the PMC 1434 may manage power provided to the baseband circuitry 1404. In particular, the PMC 1434 may control power-source selection, voltage scaling, battery charging, or DC-to-DC conversion. The PMC 1434 may often be included when the device 1400 is capable of being powered by a battery, for example, when the device 1400 is included in an EGE. The PMC 1434 may increase the power conversion efficiency while providing desirable implementation size and heat dissipation characteristics.

FIG. 14 shows the PMC 1434 coupled only with the baseband circuitry 1404. However, in other embodiments, the PMC 1434 may be additionally or alternatively coupled with, and perform similar power management operations for, other components, such as, but not limited to, the application circuitry 1402, the RF circuitry 1420, or the FEM circuitry 1430.

In some embodiments, the PMC 1434 may control, or otherwise be part of, various power saving mechanisms of the device 1400. For example, if the device 1400 is in an RRC Connected state, where it is still connected to the RAN node as it expects to receive traffic shortly, then it may enter a state known as Discontinuous Reception Mode (DRX) after a period of inactivity. During this state, the device 1400 may power down for brief intervals of time and thus save power.

If there is no data traffic activity for an extended period of time, then the device 1400 may transition off to an RRC Idle state, where it disconnects from the network and does not perform operations, such as channel quality feedback, handover, etc. The device 1400 goes into a very low power state and it performs paging where again it periodically wakes up to listen to the network and then powers down again. The device 1400 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1402 and processors of the baseband circuitry 1404 may be used to execute elements of one or more instances of a protocol stack. For example, processors of the baseband circuitry 1404, alone or in combination, may be used to execute Layer 3, Layer 2, or Layer 1 functionality, while processors of the application circuitry 1402 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

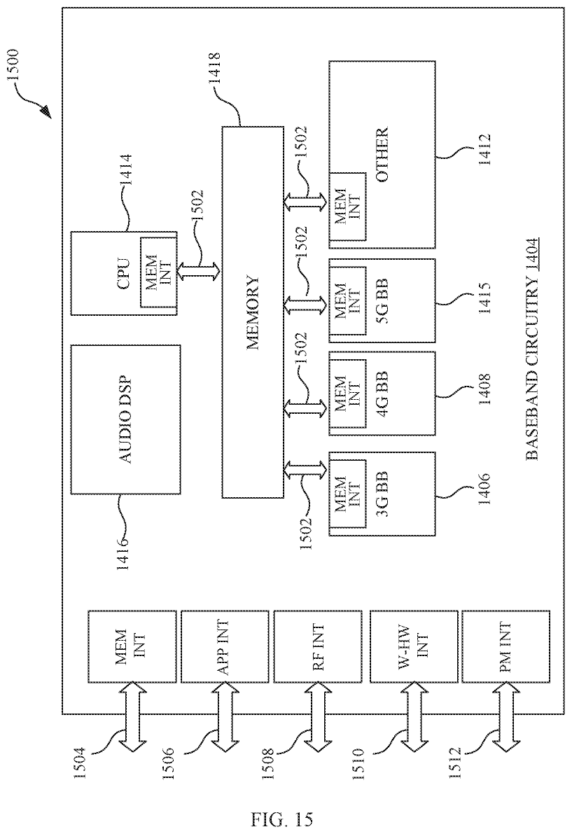

FIG. 15 illustrates example interfaces 1500 of baseband circuitry in accordance with some embodiments. As discussed above, the baseband circuitry 1404 of FIG. 14 may include 3G baseband processor 1406, 4G baseband processor 1408, 5G baseband processor 1410, other baseband processor(s) 1412, CPU 1414, and a memory 1418 utilized by said processors. As illustrated, each of the processors may include a respective memory interface 1402 to send/receive data to/from the memory 1418.

The baseband circuitry 1404 may further include one or more interfaces to communicatively couple to other circuitries/devices, such as a memory interface 1504 (e.g., an interface to send/receive data to/from memory external to the baseband circuitry 1504), an application circuitry interface 1506 (e.g., an interface to send/receive data to/from the application circuitry 1402 of FIG. 14), an RF circuitry interface 1508 (e.g., an interface to send/receive data to/from RF circuitry 1420 of FIG. 14), a wireless hardware connectivity interface 1510 (e.g., an interface to send/receive data to/from Near Field Communication (NFC) components, Bluetooth® components (e.g., Bluetooth® Low Energy), Wi-Fi® components, and other communication components), and a power management interface 1512 (e.g., an interface to send/receive power or control signals to/from the PMC 1534).

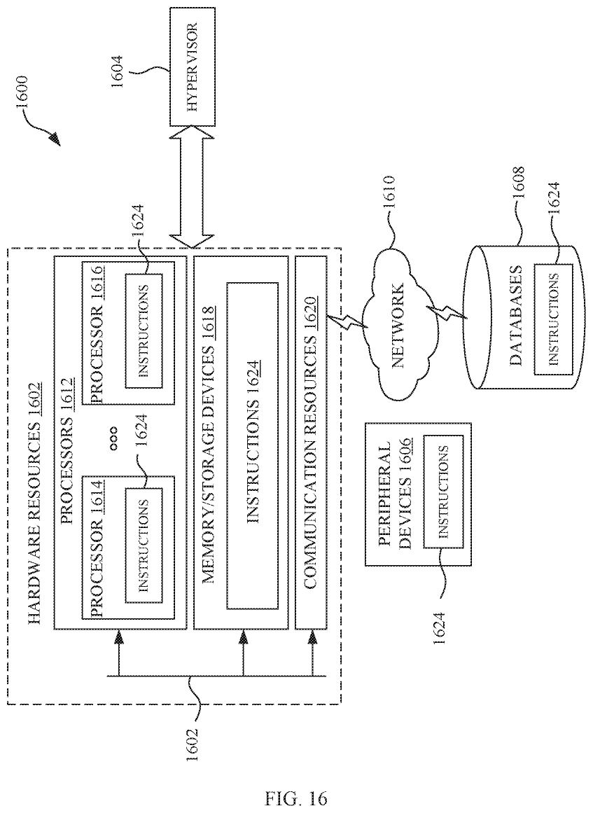

FIG. 16 is a block diagram illustrating components 1600, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1602 including one or more processors 1612 (or processor cores), one or more memory/storage devices 1618, and one or more communication resources 1620, each of which may be communicatively coupled via a bus 1622. For embodiments where node virtualization (e.g., NFV) is utilized, a hypervisor 1604 may be executed to provide an execution environment for one or more network slices/sub-slices to utilize the hardware resources 1602.

The processors 1612 (e.g., a central processing unit (CPU), a reduced instruction set computing (RISC) processor, a complex instruction set computing (CISC) processor, a graphics processing unit (GPU), a digital signal processor (DSP), such as a baseband processor, an application specific integrated circuit (ASIC), a radio-frequency integrated circuit (RFIC), another processor, or any suitable combination thereof) may include, for example, a processor 1614 and a processor 1616.

The memory/storage devices 1618 may include main memory, disk storage, or any suitable combination thereof. The memory/storage devices 1618 may include, but are not limited to, any type of volatile or non-volatile memory, such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1620 may include interconnection or network interface components or other suitable devices to communicate with one or more peripheral devices 1606 or one or more databases 1608 via a network 1610. For example, the communication resources 1620 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1624 may include software, a program, an application, an applet, an app, or other executable code for causing at least any of the processors 1612 to perform any one or more of the methodologies discussed herein. The instructions 1624 may reside, completely or partially, within at least one of the processors 1612 (e.g., within the processor's cache memory), the memory/storage devices 1618, or any suitable combination thereof. Furthermore, any portion of the instructions 1624 may be transferred to the hardware resources 1602 from any combination of the peripheral devices 1606 or the databases 1608. Accordingly, the memory of the processors 1612, the memory/storage devices 1618, the peripheral devices 1606, and the databases 1608 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

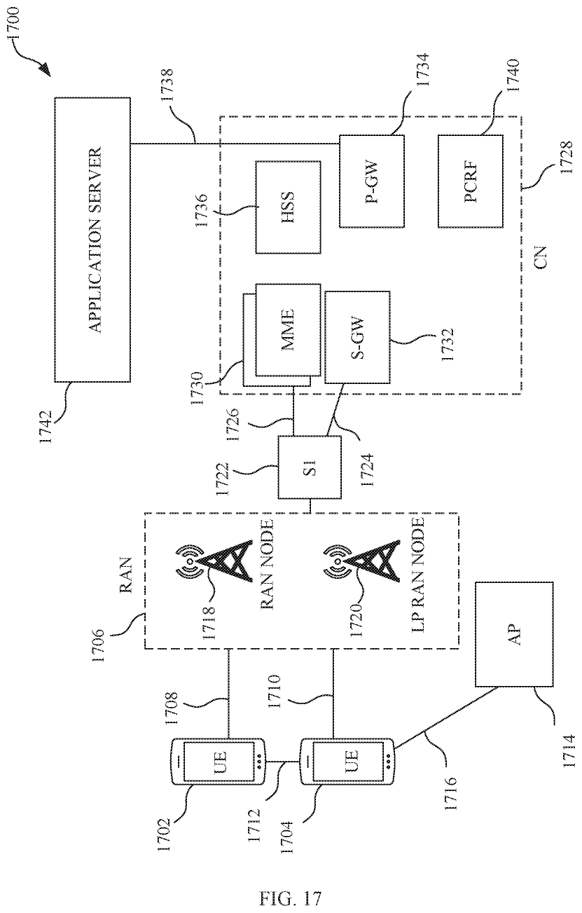

FIG. 17 illustrates an architecture of a system 1700 of a network in accordance with some embodiments. The system 1700 includes one or more user equipment (UE), shown in this example as a UE 1702 and a UE 1704. The UE 1702 and the UE 1704 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, any of the UE 1702 and the UE 1704 can include an Internet of Things (IoT) UE, which can include a network access layer designed for low-power IoT applications utilizing short-lived UE connections. An IoT UE can utilize technologies, such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1702 and the UE 1704 may be configured to connect, e.g., communicatively couple, with a radio access network (RAN), shown as RAN 1706. The RAN 1706 may be, for example, an Evolved ETniversal Mobile Telecommunications System (ETMTS) Terrestrial Radio Access Network (E-UTRAN), a NextGen RAN (NG RAN), or some other type of RAN. The UE 1702 and the UE 1704 utilize connection 1708 and connection 1710, respectively, each of which includes a physical communications interface or layer (discussed in further detail below); in this example, the connection 1708 and the connection 1710 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1702 and the UE 1704 may further directly exchange communication data via a ProSe interface 1712. The ProSe interface 1712 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1704 is shown to be configured to access an access point (AP), shown as AP 1714, via connection 1716. The connection 1716 can include a local wireless connection, such as a connection consistent with any IEEE 802.11 protocol, wherein the AP 1714 would include a wireless fidelity (WiFi®) router. In this example, the AP 1714 may be connected to the Internet without connecting to the core network of the wireless system (described in further detail below).

The RAN 1706 can include one or more access nodes that enable the connection 1708 and the connection 1710. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 1706 may include one or more RAN nodes for providing macrocells, e.g., macro RAN node 1718, and one or more RAN nodes for providing femtocells or picocells (e.g., cells having smaller coverage areas, smaller user capacity, or higher bandwidth compared to macrocells), e.g., a low power (LP) RAN node, such as LP RAN node 1720.

Any of the macro RAN node 1718 and the LP RAN node 1720 can terminate the air interface protocol and can be the first point of contact for the UE 1702 and the UE 1704. In some embodiments, any of the macro RAN node 1718 and the LP RAN node 1720 can fulfill various logical functions for the RAN 1706 including, but not limited to, radio network controller (RNC) functions, such as radio bearer management, uplink and downlink dynamic radio resource management and data packet scheduling, and mobility management.

In accordance with some embodiments, the EGE 1702 and the EGE 1704 can be configured to communicate using Orthogonal Frequency-Division Multiplexing (OFDM) communication signals with each other or with any of the macro RAN node 1718 and the LP RAN node 1720 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 1718 and the LP RAN node 1720 to the UE 1702 and the UE 1704, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1702 and the UE 1704. The physical downlink control channel (PDCCH) may carry information about the transport format and resource allocations related to the PDSCH channel, among other things. It may also inform the UE 1702 and the UE 1704 about the transport format, resource allocation, and H-ARQ (Hybrid Automatic Repeat Request) information related to the uplink shared channel. Typically, downlink scheduling (assigning control and shared channel resource blocks to the UE 1704 within a cell) may be performed at any of the macro RAN node 1718 and the LP RAN node 1720 based on channel quality information fed back from any of the UE 1702 and UE 1704. The downlink resource assignment information may be sent on the PDCCH used for (e.g., assigned to) each of the UE 1702 and the UE 1704.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1706 is communicatively coupled to a core network (CN), shown as CN 1728, via an S1 interface 1722. In embodiments, the CN 1728 may be an evolved packet core (EPC) network, a NextGen Packet Core (NPC) network, or some other type of CN. In this embodiment the S1 interface 1722 is split into two parts: the S1-U interface 1724, which carries traffic data between the macro RAN node 1718 and the LP RAN node 1720 and a serving gateway (S-GW), shown as S-GW 1132, and an S1-mobility management entity (MME) interface, shown as S1-MME interface 1726, which is a signaling interface between the macro RAN node 1718 and LP RAN node 1720 and the MME(s) 1730.

In this embodiment, the CN 1728 includes the MME(s) 1730, the S-GW 1732, a Packet Data Network (PDN) Gateway (P-GW) (shown as P-GW 1734), and a home subscriber server (HSS) (shown as HSS 1736). The MME(s) 1730 may be similar in function to the control plane of legacy Serving General Packet Radio Service (GPRS) Support Nodes (SGSN). The MME(s) 1730 may manage mobility aspects in access such as gateway selection and tracking area list management. The HSS 1736 may include a database for network users, including subscription-related information to support the network entities' handling of communication sessions. The CN 1728 may include one or several HSS 1736, depending on the number of mobile subscribers, on the capacity of the equipment, on the organization of the network, etc. For example, the HSS 1736 can provide support for routing/roaming, authentication, authorization, naming/addressing resolution, location dependencies, etc.

The S-GW 1732 may terminate the S1 interface 1722 towards the RAN 1706, and route data packets between the RAN 1706 and the CN 1728. In addition, the S-GW 1732 may be a local mobility anchor point for inter-RAN node handovers and also may provide an anchor for inter-3 GPP mobility. Other responsibilities may include lawful intercept, charging, and some policy enforcement.

The P-GW 1734 may terminate an SGi interface toward a PDN. The P-GW 1734 may route data packets between the CN 1728 (e.g., an EPC network) and external networks, such as a network including the application server 1742 (alternatively referred to as application function (AF)) via an Internet Protocol (IP) interface (shown as IP communications interface 1738). Generally, an application server 1742 may be an element offering applications that use IP bearer resources with the core network (e.g., ETMTS Packet Services (PS) domain, LTE PS data services, etc.). In this embodiment, the P-GW 1734 is shown to be communicatively coupled to an application server 1742 via an IP communications interface 1738. The application server 1742 can also be configured to support one or more communication services (e.g., Voice-over-Internet Protocol (VOIP) sessions, PTT sessions, group communication sessions, social networking services, etc.) for the UE 1702 and the UE 1704 via the CN 1728.

The P-GW 1734 may further be a node for policy enforcement and charging data collection. A Policy and Charging Enforcement Function (PCRF) (shown as PCRF 1740) is the policy and charging control element of the CN 1728. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1740 may be communicatively coupled to the application server 1742 via the P-GW 1734. The application server 1742 may signal the PCRF 1740 to indicate a new service flow and select the appropriate Quality of Service (Qos) and charging parameters. The PCRF 1740 may provision this rule into a Policy and Charging Enforcement Function (PCEF) (not shown) with the appropriate traffic flow template (TFT) and QoS class of identifier (QCI), which commences the QoS and charging as specified by the application server 1742.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate, in accordance with one or more of the examples set forth below. For another example, circuitry associated with a UE, base station, network element, etc., as described above in connection with one or more of the preceding figures may be configured to operate in accordance with one or more of the examples set forth below in the example section. The following examples pertain to further embodiments.

Example 1 is a method for a user equipment (UE), comprising:
obtaining a first control information from a network device, wherein the first control information indicates at least one physical downlink control channel (PDCCH) monitoring period for the UE; and
monitoring PDCCH based on the at least one PDCCH monitoring period.

Example 2 is the method of Example 1, wherein the first control information comprises a plurality of discontinuous reception (DRX) configurations, wherein each of the plurality of DRX configurations indicates at least one DRX On period, and wherein the monitoring the PDCCH based on the at least one PDCCH monitoring period comprises:
monitoring PDCCH based on the respective at least one DRX On period indicated by each of the plurality of DRX configurations.

Example 3 is the method of Example 2, further comprising:
obtaining a second control information from the network device, wherein the second control information causes the UE to perform at least one operation selected from a group consisting of:
   activation of at least one DRX configuration of the plurality of DRX configurations: and
   deactivation of at least one DRX configuration of activated DRX configurations, and
wherein the monitoring PDCCH based on respective the at least one DRX On period indicated by each of the plurality of DRX configurations comprises:
   monitoring PDCCH based on the respective at least one DRX On period indicated by each of the activated DRX configurations.

Example 4 is the method of Example 3, wherein the second control information is transmitted via a Radio Resource Control (RRC) signaling or a Medium Access Control (MAC) Control Element (CE).

Example 5 is the method of Example 4, wherein in a case where the second control information is transmitted via the MAC CE, the taking effect time of the activation is selected from a group consisting of:
after a first nominal DRX On period after a Hybrid Automatic Repeat Request (HARQ) acknowledgement (HARQ-ACK) for a Physical Downlink Shared Channel (PDSCH) containing the MAC CE:
   a first predetermined time after the HARQ-ACK for a PDSCH containing the MAC CE;
   at a boundary of a time unit selected from a group consisting of a slot, half-radio frame, and a radio frame; and
   a second predetermined time after a transmission of an uplink MAC CE by the UE upon a reception of the MAC CE associated with the second control information.

Example 6 is the method of Example 2, further comprising:
obtaining a third control information from the network device, wherein the third control information causes the UE to perform at least one operation selected from a group consisting of:
   modification of at least one DRX configuration of the plurality of DRX configurations;
   addition of at least one DRX configuration to the plurality of DRX configurations; and
   removal of at least one DRX configuration from the plurality of DRX configurations.

Example 7 is the method of Example 6, wherein the third control information is transmitted via an RRC signaling.

Example 8 is the method of Example 2, wherein each of the plurality of DRX configurations comprises at least one of a periodicity and an offset, and wherein the plurality of DRX configurations shares at least one unconfigurable parameter of a same value.

Example 9 is the method of Example 1, wherein the first control information comprises a modified DRX configuration, wherein the modified DRX configuration indicates a plurality of DRX On period sets by a plurality of configurable parameter sets, respectively, wherein each of the plurality of parameter sets comprises at least one of a periodicity and an offset, and wherein the monitoring PDCCH based on the at least one PDCCH monitoring period comprises:
monitoring PDCCH based on the plurality of DRX On period sets.

Example 10 is the method of Example 1, wherein the first control information comprises a plurality of DRX configuration sets, wherein each of the plurality of DRX configuration sets comprises at least one DRX configuration, and each of the at least one DRX configuration indicates at least one DRX On period, wherein the method further comprises:
obtaining a fourth control information from the network device, wherein the fourth control information indicates a target DRX configuration set from the plurality of DRX configuration sets, and
wherein the monitoring PDCCH based on the at least one PDCCH monitoring period comprises:
   monitoring PDCCH based on the respective at least one DRX On period indicated by each of at least one DRX configuration comprised in the target DRX configuration.

Example 11 is the method of Example 10, wherein the fourth control information is transmitted via dynamic signaling of a Downlink Control Information (DCI), and wherein a plurality of code states of the DCI corresponds to the plurality of DRX configuration sets, respectively.

Example 12 is the method of Example 2, further comprising:
obtaining a fifth control information from the network device, wherein the fifth control information comprises a wake-up signal (WUS) configuration indicating at least one wake-up period associated with the respective at least one DRX On period indicated by each of the plurality of DRX configurations, and
wherein the monitoring PDCCH based on the at least one PDCCH monitoring period comprises:
   monitoring PDCCH based on the respective at least one DRX On period indicated by each of the plurality of DRX configurations and the at least one wake-up period indicated by the WUS configuration.

Example 13 is the method of Example 1, further comprising:
determining a traffic behavior of the UE for transmission to the network device, wherein the traffic behavior comprises a plurality of traffic compositions and a traffic pattern for each of the plurality of traffic composition, and wherein the first control information is generated by the network device based on the traffic behavior.

Example 14 is the method of Example 13, further comprising:
obtaining a sixth control information from the network device, wherein the sixth control information comprises a plurality of WUS configurations corresponding to the plurality of traffic compositions, respectively, wherein the plurality of WUS configuration indicates at least one wake-up period associated with the at least one PDCCH monitoring period, and
wherein the monitoring PDCCH based on the at least one PDCCH monitoring period comprises:
   monitoring PDCCH based on the at least one PDCCH monitoring period and the at least one wake-up period.

Example 15 is the method of Example 2, further comprising:
obtaining a seventh control information from the network device, wherein the seventh control information comprises a plurality of WUS configurations corresponding to the plurality of DRX configurations, respectively, wherein each of the plurality of WUS configuration indicates at least one wake-up period associated with at least one DRX On period indicated by a corresponding DRX configurations, and
wherein the monitoring PDCCH based on the at least one PDCCH monitoring period comprises:
   monitoring PDCCH based on the respective at least one DRX On period indicated by each of the plurality of DRX configurations and the respective at least one wake-up period indicated by each of the plurality of WUS configurations.

Example 16 is the method of Example 1, wherein the first control information comprises a Semi-Persistent Scheduling (SPS) configuration, wherein the SPS configuration specifies one or more parameters for a corresponding HARQ process identifying at least one DL retransmission scheduling PDCCH monitoring period, wherein the one or more parameters comprises a drx-HARQ-RTT-TimerDL and a drx-RetransmissionTimerDL, and
wherein the monitoring PDCCH based on the at least one PDCCH monitoring period comprises:
   monitoring PDCCH based on the at least one DL retransmission scheduling PDCCH monitoring period.

Example 17 is the method of Example 16, wherein the one or more parameters are set according to one selected from a group consisting of:
the drx-HARQ-RTT-TimerDL is greater than a third predetermined time;
the drx-HARQ-RTT-TimerDL is set to infinity;
the drx-RetransmissionTimerDL is set to zero,
the drx-HARQ-RTT-TimerDL is equal to the drx-Retransmission TimerDL;
the drx-HARQ-RTT-TimerDL is less than a fourth predetermined time; and
the drx-HARQ-RTT-TimerDL and the drx-Retransmission TimerDL are both equal to 0.

Example 18 is the method of Example 16, wherein at least one of the drx-HARQ-RTT-TimerDL and the drx-RetransmissionTimer DL is set to a predefined state indicating a total length of the at least one DL retransmission scheduling PDCCH monitoring period is equal to 0.

Example 19 is the method of Example 16, wherein for a SPS retransmission, the one or more parameters of the corresponding HARQ process are set according to one of:
a common configuration as in DRX for an SPS dynamic retransmission scheduled by PDCCH masked by Configured Scheduling-Radio Network Temporary Identity (CS-RNTI): and
the SPS configuration for an SPS dynamic retransmission scheduled by PDCCH masked by CS-RNTI.

Example 20 is the method of Example 16, wherein the one or more parameters of the corresponding HARQ process are set according to a common configuration as in DRX once the corresponding HARQ process is used by a dynamic signaling of PDCCH not masked by CS-RNTI.

Example 21 is the method of Example 1, wherein the first control information comprises a Configured Grant (CG) configuration, wherein the CG configuration specifies one or more parameters for a corresponding HARQ process identifying at least one UL retransmission scheduling PDCCH monitoring period, wherein the one or more parameters comprise drx-HARQ-RTT-TimerUL and drx-RetransmissionTimerUL, and
wherein the monitoring PDCCH based on the at least one PDCCH monitoring period comprises:
monitoring PDCCH based on the at least one UL retransmission scheduling PDCCH monitoring period.

Example 22 is the method of Example 21, wherein the one or more parameters is set according to one selected from a group consisting of:
the drx-HARQ-RTT-TimerUL is greater than a fifth predetermined time;
the drx-HARQ-RTT-Timer UL is set to infinity;
the drx-RetransmissionTimerUL is set to zero;
the drx-HARQ-RTT-Timer UL is equal to the drx-Retransmission Timer UL;
the drx-HARQ-RTT-Timer UL is less than a sixth predetermined time; and
the drx-HARQ-RTT-TimerUL and the drx-RetransmissionTimerUL are both equal to 0.

Example 23 is the method of Example 21, wherein at least one of the drx-HARQ-RTT-Timer UL and the drx-RetransmissionTimerUL is set to a predefined state indicating a total length of the at least one UL retransmission scheduling PDCCH monitoring period is equal to 0.

Example 24 is the method of Example 21, wherein for CG retransmission, the one or more parameters of the corresponding HARQ process are set according to one selected from a group consisting of:
a common DRX configuration for a CG dynamic retransmission scheduled by PDCCH masked by CS-RNTI; and
the CG configuration for a CG dynamic retransmission scheduled by PDCCH masked by CS-RNTI.

Example 25 is the method of Example 21, wherein the one or more parameters of the corresponding HARQ process are set according to a common DRX configuration once the corresponding HARQ process is used by a dynamic signaling of PDCCH not masked by CS-RNTI.

Example 26 is the method of Example 1, wherein the first control information comprises a plurality of parameter value sets for one or more parameters identifying at least one retransmission scheduling PDCCH monitoring period, and
wherein the monitoring PDCCH based on the at least one PDCCH monitoring period comprises:
monitoring PDCCH based on the at least one retransmission scheduling PDCCH monitoring period.

Example 27 is the method of Example 26, wherein the one or more parameters are for DL retransmission, wherein the plurality of parameter value sets comprises a first parameter value set and a second parameter value set, wherein the UE comprises a first UE capability and a second UE capability that is greater than the first UE capability, wherein the first and second parameter value set corresponds to the first and second UE capability, respectively,
wherein the method further comprises:
determining using the first parameter value set or the second parameter value set based on a DCI from the network device.

Example 28 is the method of Example 27, wherein the determining using the first parameter value set or the second parameter value set comprises:
in response to determining a format of the DCI is DCI 1_0, determining using the first parameter value set.

Example 29 is the method of Example 27, wherein the determining using the first parameter value set or the second parameter value set comprises:
in response to determining a format of the DCI is DCI 1_0, and only a front load Demodulation Reference Signal (DMRS) is used, determining using the second parameter value set.

Example 30 is the method of Example 27, wherein in a case where the UE is configured with a Dynamic Grant (DG) configuration, the DCI is a scheduling DCI, and wherein in a case where the UE is configured with an SPS configuration, the DCI is an activation DCI.

Example 31 is the method of Example 27, wherein the first and second UE capability is determined based on physical layer resource allocation, wherein the physical layer resource allocation comprises at least one selected from a group consisting of a Physical Uplink Shared Channel (PUSCH) duration, a Physical Downlink Shared Channel (PDSCH) duration, Sub-Carrier Spaces (SCS), cells, and Band Width Parts (BWP).

Example 32 is the method of Example 26, wherein the one or more parameters are for UL retransmission, wherein the plurality of parameter value sets comprises a first parameter value set and a second parameter value set, wherein the UE comprises a first UE capability and a second UE capability that is greater than the first UE capability, wherein the first and second parameter value set corresponds to the first and second UE capability, respectively, wherein the method further comprises:
determining using the first parameter value set or the second parameter value set based on a high layer parameter processingType2Enabled in PUSCH-ServingCellConfig.

Example 33 is the method of Example 32, wherein the determining using the first parameter value set or the second parameter value set comprises:
in response to determining the parameter processingType2Enabled is configured and is set to enable, determining using the second parameter value set; and
in response to determining the parameter processingType2Enabled is not configured or is not set to enable, determining using the first parameter value set.

Example 34 is the method of Example 26, further comprising:
obtaining an eighth control information from the network device, wherein the eighth control information indicates a target parameter value set from the plurality of parameter value sets.

Example 35 is the method of Example 34, wherein the eighth control information is transmitted via dynamic signaling of a DCI, and wherein a plurality of code states of the DCI corresponds to the plurality of parameter value sets, respectively.

Example 36 is the method of Example 34, wherein the eighth control information is transmitted via dynamic signaling of a DCI and a MAC CE, and wherein the MAC CE specifies a portion of the plurality of parameter value sets, and each code state of the DCI corresponds to a parameter value set in the portion of the plurality of parameter value sets.

Example 37 is the method of Example 26, wherein the plurality of parameter value sets is associated with a plurality of component carriers (CC), and the method further comprises:
determining a target parameter value set based on a CC of a corresponding PDSCH.

Example 38 is the method of Example 26, wherein the plurality of parameter value sets is associated with a plurality of subsets of HARQ processes, and the method further comprises:
determining a target parameter value set based on a subset to which a corresponding HARQ process belongs.

Example 39 is the method of Example 26, wherein a portion of the plurality of parameter value sets are set according to a common DRX configuration, and the plurality of parameter value sets are associated with a plurality of DCI formats, and the method further comprises:
determining a target parameter value set based on a format of a DCI from the network device.

Example 40 is the method of Example 26, wherein in a case where a CG configuration is configured for the UE, a cg-RetransmissionTimer is set to be greater than a seventh predetermined time.

Example 41 is the method of Example 21, wherein in a case where a UL skipping is used, the one or more parameters of the corresponding HARQ process are not set according to the at least one UL traffic configuration.

Example 42 is the method of Example 26, wherein in a case where a DL skipping is used, none of the one or more parameters is used.

Example 43 is the method of Example 26, wherein the UE is configured with at least one DRX configuration, wherein the at least one DRX configuration indicates at least one DRX On period, and wherein for a retransmission scheduling PDCCH monitoring period in the at least one retransmission scheduling PDCCH monitoring period, in a case where the retransmission scheduling PDCCH monitoring period fully encloses a DRX On period in the at least one DRX On period, the retransmission scheduling PDCCH monitoring period is shrunken to align with the DRX On period.

Example 44 is a method for a network device, comprising:
determining a traffic behavior for a UE, wherein the traffic behavior comprises a plurality of traffic compositions and a traffic pattern for each of the plurality of traffic composition; and
generating a first control information for transmission to the UE based on the traffic behavior, wherein the first control information indicates at least one physical downlink control channel (PDCCH) monitoring period for the UE.

Example 45 is the method of Example 44, wherein the first control information comprises a plurality of discontinuous reception (DRX) configurations, wherein each of the plurality of DRX configurations indicates at least one DRX On period.

Example 46 is the method of Example 45, further comprising:
generating a second control information for transmission to the UE, wherein the second control information causes the UE to perform at least one operation selected from a group consisting of:
   activation of at least one DRX configuration of the plurality of DRX configurations: and
   deactivation of at least one DRX configuration of activated DRX configurations.

Example 47 is the method of Example 46, wherein the second control information is transmitted via a Radio Resource Control (RRC) signaling or a Medium Access Control (MAC) Control Element (CE).

Example 48 is the method of Example 45, further comprising:
generating a third control information for transmission to the UE, wherein the third control information causes the UE to perform at least one operation selected from a group consisting of:
   modification of at least one DRX configuration of the plurality of DRX configurations;
   addition of at least one DRX configuration to the plurality of DRX configurations; and
   removal of at least one DRX configuration from the plurality of DRX configurations.

Example 49 is the method of Example 48, wherein the third control information is transmitted via an RRC signaling.

Example 50 is the method of Example 44, wherein the first control information comprises a plurality of DRX configuration sets, wherein each of the plurality of DRX configuration sets comprises at least one DRX configuration, and each of the at least one DRX configuration indicates at least one DRX On period, wherein the method further comprises:
generating a fourth control information for transmission to the UE, wherein the fourth control information indicates a target DRX configuration set from the plurality of DRX configuration sets.

Example 51 is the method of Example 50, wherein the fourth control information is transmitted via dynamic signaling of a Downlink Control Information (DCI), and wherein a plurality of code states of the DCI corresponds to the plurality of DRX configuration sets, respectively.

Example 52 is the method of Example 50, further comprising:
generating a fifth control information for transmission to the UE, wherein the fifth control information comprises a wake-up signal (WUS) configuration indicating at least one wake-up period associated with the respective at least one DRX On period indicated by each of the plurality of DRX configurations.

Example 53 is the method of Example 44, further comprising:
generating a sixth control information for transmission to the UE, wherein the sixth control information comprises a plurality of WUS configurations corresponding to the plurality of traffic compositions, respectively, wherein the plurality of WUS configuration indicates at least one wake-up period associated with the at least one PDCCH monitoring period.

Example 54 is the method of Example 45, further comprising:
generating a seventh control information for transmission to the UE, wherein the seventh control information comprises a plurality of WUS configurations corresponding to the plurality of DRX configurations, respectively, wherein each of the plurality of WUS configuration indicates at least one wake-up period associated with at least one DRX On period indicated by a corresponding DRX configurations.

Example 55 is the method of Example 44, wherein the first control information comprises a Semi-Persistent Scheduling (SPS) configuration, wherein the SPS configuration specifies one or more parameters for a corresponding HARQ process identifying at least one DL retransmission scheduling PDCCH monitoring period, and wherein the one or more parameters comprise a drx-HARQ-RTT-TimerDL and a drx-Retransmission Timer DL.

Example 56 is the method of Example 55, wherein in a case where a corresponding DL traffic is latency stringent, the one or more parameters are set according to one selected from a group consisting of:
the drx-HARQ-RTT-TimerDL is greater than a third predetermined time;
the drx-HARQ-RTT-TimerDL is set to infinity;
the drx-RetransmissionTimerDL is set to zero;
the drx-HARQ-RTT-TimerDL is equal to the drx-Retransmission TimerDL;
the drx-HARQ-RTT-TimerDL is less than a fourth predetermined time; and
the drx-HARQ-RTT-TimerDL and the drx-RetransmissionTimer DL are both equal to 0.

Example 57 is the method of Example 55, wherein in a case where a corresponding DL traffic is latency stringent, at least one of the drx-HARQ-RTT-TimerDL and the drx-RetransmissionTimerDL is set to a predefined state indicating a total length of the at least one DL retransmission scheduling PDCCH monitoring period is equal to 0.

Example 58 is the method of Example 44, wherein the first control information comprises a Configured Grant (CG) configuration, wherein the CG configuration specifies one or more parameters for a corresponding HARQ process identifying at least one UL retransmission scheduling PDCCH monitoring period, and wherein the one or more parameters comprise drx-HARQ-RTT-TimerUL and drx-RetransmissionTimerUL.

Example 59 is the method of Example 58, wherein in a case where a corresponding UL traffic is latency stringent, the one or more parameters are set according to one selected from a group consisting of:
the drx-HARQ-RTT-Timer UL is greater than a fifth predetermined time;
the drx-HARQ-RTT-TimerUL is set to infinity;
the drx-RetransmissionTimerUL is set to zero;
the drx-HARQ-RTT-Timer UL is equal to the drx-Retransmission TimerUL;
the drx-HARQ-RTT-TimerUL is less than a sixth predetermined time; and
the drx-HARQ-RTT-Timer UL and the drx-RetransmissionTimerUL are both equal to 0.

Example 60 is the method of Example 58, wherein in a case where a corresponding UL traffic is latency stringent, at least one of the drx-HARQ-RTT-TimerUL and the drx-RetransmissionTimerUL is set to a predefined state indicating a total length of the at least one UL retransmission scheduling PDCCH monitoring period is equal to 0.

Example 61 is the method of Example 44, further comprising:
generating an eighth control information for transmission to the UE, wherein the eighth control information indicates a parameter value set for one or more parameters identifying at least one retransmission scheduling PDCCH monitoring period, and wherein the eighth control information is transmitted via at least one of a DCI and a MAC CE.

Example 62 is an apparatus for a user equipment (UE), the apparatus comprising:
one or more processors configured to perform steps of the method according to any of Examples 1-43.

Example 63 is an apparatus for a base station, the apparatus comprising:
one or more processors configured to perform steps of the method according to any of Examples 44-61.

Example 64 is a computer-readable medium having computer programs stored thereon which, when executed by one or more processors, cause an apparatus to perform steps of the method according to any of Examples 1-61.

Example 65 is an apparatus for a communication device, comprising means for performing steps of the method according to any of Examples 1-61.

Example 66 is a computer program product comprising computer programs which, when executed by one or more processors, cause an apparatus to perform steps of the method according to any of Examples 1-61.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-66. (canceled)

67. One or more non-transitory, computer-readable media having instructions that, when executed by one or more processors, cause a user equipment (UE) to:
obtain first control information from a network device, wherein the first control information indicates at least one physical downlink control channel (PDCCH) monitoring period for the UE and includes a plurality of discontinuous reception (DRX) configurations, wherein each of the plurality of DRX configurations indicates at least one DRX On period; and
monitor a PDCCH based on the respective at least one DRX On period indicated by each of the plurality of DRX configurations.

68. The one or more non-transitory, computer-readable media of claim 67, wherein the instructions, when executed, further cause the UE to:
obtain second control information from the network device, wherein the second control information causes the UE to:
activate at least one DRX configuration of the plurality of DRX configurations; or
deactivate at least one DRX configuration of activated DRX configurations, and
wherein to monitor the PDCCH based on the respective at least one DRX On period indicated by each of the plurality of DRX configurations the UE is to:
monitor PDCCH based on the respective at least one DRX On period indicated by each of the activated DRX configurations.

69. The one or more non-transitory, computer-readable media of claim 68, wherein the second control information is transmitted via a Radio Resource Control (RRC) signaling or a Medium Access Control (MAC) Control Element (CE).

70. The one or more non-transitory, computer-readable media of claim 69, wherein the second control information is transmitted via the MAC CE and an activation of at least one DRX configuration is to take effect:
after a first nominal DRX On period after a Hybrid Automatic Repeat Request (HARQ) acknowledgement (HARQ-ACK) for a Physical Downlink Shared Channel (PDSCH) containing the MAC CE;
a first predetermined time after a Hybrid Automatic Repeat Request (HARQ) acknowledgement (HARQ-ACK) for a Physical Downlink Shared Channel (PDSCH) containing the MAC CE;
at a boundary of a time unit corresponding to a slot, a half-radio frame, or a radio frame; or
a second predetermined time after a transmission of an uplink MAC CE by the UE upon a reception of the MAC CE with the second control information.

71. The one or more non-transitory, computer-readable media of claim 67, wherein the instructions, when executed, further cause the UE to:
obtain second control information from the network device, wherein the second control information causes the UE to:
modify at least one DRX configuration of the plurality of DRX configurations;
add at least one DRX configuration to the plurality of DRX configurations; or
remove at least one DRX configuration from the plurality of DRX configurations.

72. The one or more non-transitory, computer-readable media of claim 71, wherein the second control information is transmitted via radio resource control (RRC) signaling.

73. The one or more non-transitory, computer-readable media of claim 71, wherein each of the plurality of DRX configurations comprises at least one of a periodicity and an offset, and wherein the plurality of DRX configurations shares at least one unconfigurable parameter of a same value.

74. A method for a network device, comprising:
determining a traffic behavior for a UE, wherein the traffic behavior includes a plurality of traffic compositions and a traffic pattern for each of the plurality of traffic compositions; and
generating first control information for transmission to the UE based on the traffic behavior, wherein the first control information indicates at least one physical downlink control channel (PDCCH) monitoring period for the UE.

75. The method of claim 74, wherein the first control information comprises a plurality of discontinuous reception (DRX) configurations, wherein each of the plurality of DRX configurations indicates at least one DRX On period.

76. The method of claim 75, further comprising:
generating second control information for transmission to the UE, wherein the second control information causes the UE to:
activate at least one DRX configuration of the plurality of DRX configurations; or
deactivate at least one DRX configuration of activated DRX configurations.

77. The method of claim 75, further comprising:
generating second control information for transmission to the UE, wherein the second control information causes the UE to:
modify at least one DRX configuration of the plurality of DRX configurations;
add at least one DRX configuration to the plurality of DRX configurations; or
remove at least one DRX configuration from the plurality of DRX configurations.

78. The method of claim 75, further comprising:
generating second control information for transmission to the UE, wherein the second control information comprises a plurality of WUS configurations corresponding to the plurality of DRX configurations, respectively, wherein each of the plurality of WUS configuration indicates at least one wake-up period associated with at least one DRX On period indicated by a corresponding DRX configurations.

79. The method of claim 74, wherein the first control information comprises a plurality of DRX configuration sets, wherein each of the plurality of DRX configuration sets comprises at least one DRX configuration, and each of the at least one DRX configuration indicates at least one DRX On period, wherein the method further comprises:
generating second control information for transmission to the UE, wherein the second control information indicates a target DRX configuration set from the plurality of DRX configuration sets.

80. The method of claim 79, wherein the second control information is transmitted via Downlink Control Information (DCI), and wherein a plurality of code states of the DCI corresponds to the plurality of DRX configuration sets, respectively.

81. The method of claim 79, further comprising:
generating third control information for transmission to the UE, wherein the third control information comprises a wake-up signal (WUS) configuration indicating at least one wake-up period associated with the respective at least one DRX On period indicated by each of the plurality of DRX configurations.

82. The method of claim 74, further comprising:
generating second control information for transmission to the UE, wherein the second control information comprises a plurality of WUS configurations corresponding to the plurality of traffic compositions, respectively, wherein the plurality of WUS configuration indicates at least one wake-up period associated with the at least one PDCCH monitoring period.

83. The method of claim 74, wherein the first control information comprises a Semi-Persistent Scheduling (SPS) configuration that specifies one or more parameters for a corresponding HARQ process identifying at least one DL retransmission scheduling PDCCH monitoring period, and wherein the one or more parameters comprise a drx-HARQ-RTT-TimerDL and a drx-Retransmission TimerDL.

84. The method of claim 83, wherein in a case where a corresponding DL traffic is latency stringent, the one or more parameters are set according to whether:
the drx-HARQ-RTT-TimerDL is greater than a predetermined time;
the drx-HARQ-RTT-TimerDL is set to infinity;
the drx-Retransmission TimerDL is set to zero;
the drx-HARQ-RTT-TimerDL is equal to the drx-Retransmission TimerDL;
the drx-HARQ-RTT-TimerDL is less than a predetermined time; or
the drx-HARQ-RTT-TimerDL and the drx-Retransmission TimerDL are both equal to 0.

85. The method of claim 83, wherein a corresponding DL traffic is latency stringent and at least one of the drx-HARQ-RTT-TimerDL and the drx-Retransmission TimerDL is set to a predefined state indicating a total length of the at least one DL retransmission scheduling PDCCH monitoring period is equal to 0.

86. The method of claim 74, wherein the first control information comprises a Configured Grant (CG) configuration, wherein the CG configuration specifies one or more parameters for a corresponding HARQ process identifying at least one UL retransmission scheduling PDCCH monitoring period, and wherein the one or more parameters comprise drx-HARQ-RTT-TimerUL and drx-Retransmission TimerUL.
